(19) United States
(12) Patent Application Publication
(10) Pub. No.: US 2023/0389571 A1
(43) Pub. Date: Dec. 7, 2023

(54) HYDROPONICALLY SPROUTED CEREAL GRAINS AS A MECHANISM FOR FERTILITY IMPROVEMENT AND INCREASED CONCEPTION RATES, FEED EFFICIENCY, AND POSTPARTUM ENERGY IN RUMINANTS

(71) Applicant: HydroGreen, Inc., Langley (CA)

(72) Inventor: Shawn Jenkins, Colton, SD (US)

(73) Assignee: HydroGreen, Inc., Langley (CA)

(21) Appl. No.: 17/833,136

(22) Filed: Jun. 6, 2022

(51) Int. Cl. A23K 10/30

(52) U.S. Cl. CPC A23K 10/30

(57) ABSTRACT

Processes and methods for hydroponically sprouted cereal grains are disclosed as a mechanism for increasing fertility rates, postpartum milk production, postpartum energy balance and maintaining a healthy pregnancy in ruminants by administering to a ruminant a feed ration having at least one feed component having one or more hydroponically sprouted cereal grains.

### FIELD OF THE DISCLOSURE

The present disclosure relates to fertility improvement and conception rates in ruminants. More particularly, but not exclusively, the present disclosure relates to hydroponically sprouted cereal grains as a mechanism for fertility improvement and increased conception rates, feed efficiency, and postpartum energy in ruminants.

### BACKGROUND

Improvements in fertility have been identified as an area of opportunity in commercial dairy operations. Without intervention, higher milk production on a per animal basis is commonly correlated with reduced fertility rates in dairy cattle leading to challenging balancing act for commercial operators (Lopez et al., 2004; Dobson et al., 2008; Albarrán-Portillo and Pollott, 2013). In contrast to chemical intervention, nutritional management approaches have shown promise in improving fertility without negatively impacting production yet show challenge in commercial application. Through leveraging associations between dietary intake and the development of ovarian follicles, oocytes, and embryos in ruminants, positive changes in fertility have been demonstrated in research settings, but specifically altering nutrient management approaches on farm to support improved fertility remains a challenge (Lucy, 2003; Dupont et al., 2014; Zebeli et al., 2015). Therefore, what is needed is a method and system for leveraging nutrients in hydroponically grown sprouts which improve the development of ovarian follicles, oocytes, and embryos to increase fertility rates and conception rates in ruminants.

### SUMMARY

Therefore, it is a primary object, feature, or advantage of the present disclosure to improve over the state of the art.

It is a further object, feature, or advantage of the present disclosure to increase fertility rates in ruminants.

It is a still further object, feature, or advantage of the present disclosure to increase conception rates in ruminants.

Another object, feature, or advantage is to increase dry matter intake during periparturient period.

Yet another object, feature, or advantage is to increase progesterone levels utilizing a feed composition that includes hydroponically grown sprouts.

Another object, feature, or advantage is to increase ovulation rates.

It is still a further object, feature, or advantage is to increase milk production postpartum in dairy cattle.

Yet another object, feature, or advantage is to increase conception rates at the onset of maturity in ruminants.

Yet another object, feature, or advantage is to increase fertility at the periparturient stage in ruminants.

In one aspect of the present disclosure a method for hydroponically sprouted cereal grains as a mechanism for increasing fertility rates in ruminants is disclosed. The method may include administering to a ruminant a feed ration having at least one feed component that may include one or more hydroponically sprouted cereal grains for increasing fertility rates in a ruminant.

In another aspect of the present disclosure a method for increasing conception rates in a ruminant is disclosed. The method may include hydroponically sprouting one or more cereal grains for at least one feed component for ruminants. The method may also include feeding the ruminant a feed ration having the at least one feed component that may include the one or more hydroponically sprouted cereal grains for increasing conception rates in the ruminant. The method may also include increasing insulin levels in the ruminant with the feed ration. The increase in insulin levels may support the development of reproductive structures within the ruminant.

In yet another aspect of the present disclosure a system for hydroponically sprouted cereal grains as a mechanism for increasing fertility rates of a ruminant is disclosed. The system may include a grower for hydroponically sprouting one or more cereal grains for growing at least one feed component for ruminants. The system may also include a feed ration having the at least one feed component that may include the one or more hydroponically sprouted cereal grains for increasing fertility rates in the ruminants.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein.

FIG. 1 is an exemplary schematic illustrating enteric methanogenesis in ruminants.

FIG. 2 is an exemplary schematic illustrating carbohydrate fermentation in the rumen.

FIG. 3 is an illustration of the interaction between phytohormones and dry matter in accordance with an illustrative aspect of the disclosure.

FIG. 4A is a pictorial representation of animal feed grown under hypoxic conditions.

FIG. 4B is a pictorial representation of animal feed grown under aerobic conditions.

FIG. 5 is chart illustrating adenosine triphosphate (ATP) production under different environmental conditions.

FIG. 6 is an illustration of the interaction between phytohormones in accordance with an illustrative aspect of the disclosure.

FIG. 7 is an exemplary illustration of the hydrolysis reaction of cellulose and xylan.

FIG. 8 is an exemplary illustration depicting the hydrolysis of maltose into two glucose molecules.

FIG. 9 is an exemplary illustration depicting Adenosine Triphosphate production.

FIG. 10 is a chart illustrating a fixed effect estimate and a 95% confidence interval of starch and ethanol soluble carbohydrate or sugar concentration on a dry matter basis days post seeding in accordance with an exemplary aspect of the disclosure.

FIG. 11 is a chart illustrating results for hydroponically sprouted test rations in periparturient observation in accordance with an exemplary aspect of the present disclosure.

FIG. 12 is a chart illustrating results for control treatment test rations in periparturient observation in accordance with an exemplary aspect of the present disclosure.

FIG. 13 is a chart illustrating results for hydroponically sprouted test rations in heifers in accordance with an exemplary aspect of the present disclosure.

FIG. 14 is a chart illustrating results for control treatment test rations in heifers in accordance with an exemplary aspect of the present disclosure.

FIG. 15 is another chart illustrating hydroponically sprouted grain test ration and control ration in accordance with an exemplary aspect of the present disclosure.

FIG. 16 is another chart illustrating hydroponically sprouted grain test ration and control ration in accordance with an exemplary aspect of the present disclosure.

FIG. 17 is an additional chart illustrating hydroponically sprouted grain test ration and control ration in accordance with an exemplary aspect of the present disclosure.

FIG. 18 is a chart illustrating nutrient composition of hydroponically grown sprouts in accordance with an exemplary aspect of the present disclosure.

FIG. 19 is a chart illustrating rumination activity in periparturient ruminants digesting the hydroponically sprouted grain test ration and the control ration.

FIG. 20 is a chart illustrating daily dray matter intake of the hydroponically sprouted grain test ration and the control ration in ruminants in accordance with an exemplary aspect of the disclosure.

FIG. 21 is a chart illustrating reticulum pH in ruminants digesting the hydroponically sprouted grain test ration and the control ration in accordance with an exemplary aspect of the disclosure.

FIG. 22 is a chart illustrating milk production in periparturient ruminants digesting the hydroponically sprouted grain test ration and the control ration in accordance with an exemplary aspect of the disclosure.

FIG. 23 is a chart illustrating reproduction rates in ruminants digesting the hydroponically sprouted grain test ration and the control ration. in accordance with an exemplary aspect of the disclosure.

FIG. 24 is a chart illustrating metritis incidence in ruminants digesting the hydroponically sprouted grain test ration and the control ration in accordance with an exemplary aspect of the disclosure.

FIG. 25 is a chart illustrating milk weights in ruminants digesting the hydroponically sprouted grain test ration and the control ration in accordance with an exemplary aspect of the disclosure.

FIG. 26 is a chart illustrating milk weights per milking in ruminants digesting the hydroponically sprouted grain test ration and the control ration in accordance with an exemplary aspect of the disclosure.

FIG. 27 is an exemplary illustration of the grower system in accordance with an illustrative aspect of the disclosure.

FIG. 28 is a side perspective view of a portion of the seed bed of the growing system in accordance with an illustrative aspect of the disclosure.

FIG. 29 is an end perspective view of a portion of the grower system further illustrating the seed bed thereof.

FIG. 30 is a side perspective view of a portion of the grower system illustrating another seed bed thereof.

FIG. 31 is a block diagram illustrating another perspective of the grower system.

FIG. 32 is a flowchart illustrating an exemplary process for increasing fertility rates.

FIG. 33 is a flowchart illustrating another exemplary process for increasing fertility rates.

### BRIEF DESCRIPTION OF THE TABLES

Illustrated aspects of the disclosure are described in detail below with reference to attached Tables, which are incorporated by reference herein and where:

Table 1 provides the composition of Hydroponically grown cereal grains (HG) and alfalfa hay (AH).

Table 2 provides periparturient observation monthly fertility metrics.

Table 3 provides breeding heifer observation statistical analysis.

### DETAILED DESCRIPTION

Fertility in ruminants is a highly complex multifactorial quantitative trait heavily influenced by genetic background, environmental factors, and dietary intake (Robinson et al., 2006). Although multiple traits influence fertility response, the metabolic energy balance of the ruminant postpartum has been positively correlated to multiple fertility structural metrics including ovulatory follicle size, follicle count, ovulation rate and estrous behavior (Lopez et al., 2004; Letelier et al., 2008; Dupont et al., 2014). To improve the metabolic energy balance of postpartum cattle, voluntary feed intake, feed efficiency or a combination of the factors must be improved in both the periparturient and postpartum periods. In practice, improving either the voluntary feed intake or feed efficiency peripartum is extremely challenging due to the reduced dietary intake of the cow leading up to calving (Grummer, 1993). This specific pattern renders the vast majority of cattle entering into a negative energy balance postpartum which as a result negatively influences fertility rates. To address the negative association, increased inclusion of concentrates are commonly introduced at the expense of fibrous ingredients in the peripartum period leading to additional dietary imbalances and a deterioration of rumen health leading into production (Zebeli et al., 2015).

Forages are by weight the main component of dairy cow rations greatly influencing milk production, farm profitability, and even cow well-being. High quality digestible forages help productive cows face the challenges derived from the increased nutrient requirements of peripartum and lactation. During the last three weeks of gestation the protein and energy needs of the cow increase, result of the development of the fetus, udder, and colostrum synthesis. Concomitantly, intake drops by nearly 30 percent predisposing cows to metabolic problems and infections post-calving. If we were to choose one single nutrient deficiency during this period with the widest range of deleterious effects on cow productivity and well-being, it would likely be hypocalcemia. Low blood calcium can result in higher risk of dystocia, uterine prolapses, retained membranes, mastitis, displaced abomasum, and overall reduced immune status.

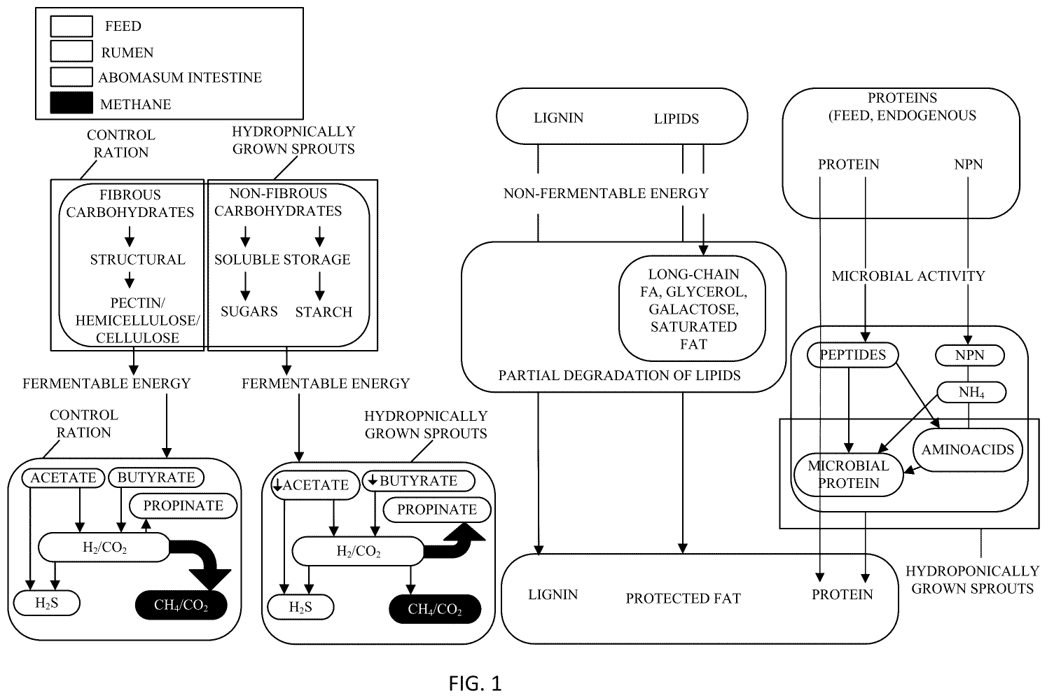

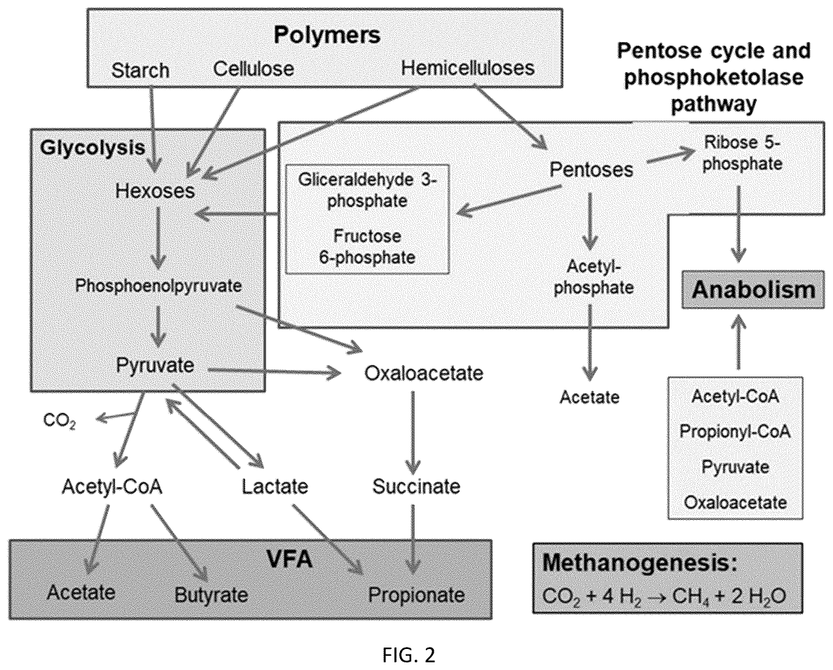

The processes, systems, and methods of the present disclosure improve fertility rates in ruminants. The processes, systems, and methods of the present disclosure provide hydroponically sprouted grains or hydroponically sprouted cereal grains as a sustainable and scalable solution to improve fertility rates and postpartum milk production in ruminants. The processes and methods of the present disclosure increase relative concentration of hexoses and thereby rates of glycolysis through inclusion of hydroponically sprouted grains to reduce dihydrogen concentrations within the rumen. Through increasing relative concentration of hexoses and in turn propionate, gluconeogenesis, and insulin levels, hydroponically sprouted cereal grains may be used as an approach to positively impact not only energy balance, but progesterone profile and ovulation rates. Favoring glycolysis through increased supplementation of hexoses supports increased production of propionate through lactate lowering acetyl-CoA and carbon dioxide pathways, as shown in FIG. 1 and FIG. 2. Especially relevant to fertility rates, elevated levels of propionate in comparison to acetate favor increased progesterone levels through the strong connection between plasma insulin and blood serum glucose concentration and propionate production (Fluharty 2003; Bines et al., 1984, Oh et al., 2015).Hydrolysis reactions external to the rumen, e.g. enzymatic hydrolysis of hemicelluloses during germination, improve efficiency of energy utilization, reduce hydrogen dioxide and carbon dioxide formation within the rumen improving feed efficiency, lower the acetate to propionate volatile fatty acid ratio supporting positive progesterone profile shifts, improve gluconeogenesis supporting improved energy balance, and support the development of reproductive structures within the animal.

Endogenous enzymes produced during controlled hydroponic germination of seeds can be used for enhancing the nutrient digestion capabilities of animal feedstuffs including feed concentrates, forages, and mineral supplements. Leveraging metabolic processes common to higher plants during germination and seedling development, the grower system enables the transformation of complex polysaccharides including starch and cellulose, complex proteins, and triglycerides into their reduced monosaccharide, amino acid, and fatty acid precursors, respectively. When enzymes are incorporated into a high starch diet, such as by increasing the amount of enzymes within a plant, and allowed time to act before animal digestion there is an overall impact on nutrient digestibility. In a six-day period, approximately 75% of the starting starch concentration and 90% of the starting protein concentration may be hydrolyzed into simpler precursors within developing cereal grains. Thereby improving efficiency of energy utilization in the ruminant, reduce hydrogen dioxide and carbon dioxide formation within the rumen improving feed efficiency, lower the acetate to propionate volatile fatty acid ratio supporting positive progesterone profile shifts, improve gluconeogenesis supporting improved energy balance, and support the development of reproductive structures within the animal.

The plant or seed may refer to any plant from the kingdom Plantae or angiosperms including flowering plants, cereal grains, grain legumes, grasses, roots and tuber crops, vegetable crops, fruit plants, pulses, medicinal crops, aromatic crops, beverage plants, sugars and starches, spices, oil plants, fiber crops, latex crops, food crops, feed crops, plantation crops or forage crops.

Cereal grains may include rice (Oryza sativa), wheat (Triticum), maize (Zea mays), rye (Secale cereale), oat (Avena sativa), barley, (Hordeum vulgare), sorghum (Sorghum bicolor), pearl millet (Pennisetum glacucum), finger millet (Eleusine coracana), barnyard millet (Echinochloa frumentacea), Italian millet (Setaria italica), kodo millet (Paspalum scrobiculatum), common millet (Panicum millaceum).

Pulses may include black gram, kalai, or urd (Vigna mungo var, radiatus), chickling vetch (Lathyrus sativus), chickpea (Cicer arietinum), cowpea (Vigna sinensis), green gram mung (Vigna radiatus), horse gram (Macrotyloma uniflorum), lentil (Lens esculenta), moth bean (Phaseolus aconitifolia), peas (Pisum sativum) pigeon pea (Cajanas cajan, Cajanus indicus), philipesara (Phaseolus trilobus), soybean (Glycine max).

Oilseeds may include black mustard (Brassica nigra), castor (Ricinus communis), coconut (Cocus nucifera), peanut (Arachis hypgaea), Indian mustard (Brassica juncea), toria (Napus), niger (Guizotia abyssinica), linseed (Linum usitatissumun), safflower (Carthamus tinctorious), sesame (Seasmum indicum), sunflower (Helianthus annus), white mustard (Brassica alba), oil palm (Elaeis guniensis). Fiber crops may include sun hemp (Crotalaria juncea), jute (Corchorus), cotton (Gossypium), mesta (Hibiscus), or tobacco (Nicotiana).

Sugar and starch crops may include potato (Solanum tberosum), sweet potato (Ipomea batatus), tapioca (Manihunt esculenta), sugarcane (Saccharum officinarum), sugar beet (Beta vulgaris). Spices may include black pepper (Piper nigrum) betel vine (Piper betle), cardamom (Elettaria cardamomum), garlic (Allium sativum), ginger (Zingiber officinale), onion (Allium cepa), red pepper or chillies (Capsicum annum), or turmeric (Curcuma longa). Forage grasses may include buffel grass or anjan (Cenchrus ciliaris), dallis grass (Paspalum dilatatum), dinanath grass (Pennisetum), guniea grass (Panicum maximum), marvel grass (Dicanthium annulatum), napier or elephant grass (Pennisetum purpureum), pangola grass (Digitaria decumbens), para grass (Brachiaria mutica), sudan grass (Sorghum sudanense), teosinte (Echlaena mexicana), or blue panicum (Panicum antidotale). Forage legume crops may include berseem or Egyptian clover (Trifolium alexandrinum), centrosema (Centrosema pubescens), gaur or cluster bean (Cyamopsis tetragonoloba), Alfalfa or lucerne (Medicago sativa), sirato (Macroptlium atropurpureum), velvet bean (Mucuna cochinchinensis).

Plantation crops may include banana (Musa paradisiaca), areca palm (Areca catechu), arrowroot (Maranta arundinacea), cacao (Theobroma cacao), coconut (Cocos nucifera), Coffee (Coffea arabica), tea (Camellia theasinesis). Vegetable crops may include ash gourd (Beniacasa cerifera), bitter gourd (Momordica charantia), bottle gourd (Lagenaria leucantha), brinjal (Solanum melongena), broad bean (Vicia faba), cabbage (Brassica), carrot (Daucus carota), cauliflower (Brassica), colocasia (Colocasia esulenta), cucumber (Cucumis sativus), double bean (Phaseolus lunatus), elephant ear or edible arum (Colocasia antiquorum), elephant foot or yam (Amorphophallus campanulatus), French bean (Phaseolus vlugaris), knol khol (Brassica), yam (Dioscorea) lettuce (Lactuca sativa), musk melon (Cucumis melo), pointed gourd or parwal (Trichosanthes diora), pumpkin (Cucrbita), radish (Raphanus sativus), bhendi (Abelmoschus esculentus), ridge gourd (Luffa acutangular), spinach (Spinacia oleracea), snake gourd (Trichosanthes anguina), tomato (Lycoperscium esculentus), turnip (Brassica), or watermelon (Citrullus vulgaris).

Medicinal crops may include aloe (Aloe vera), ashwagnatha (Withania somnifera), belladonna (Atropa belladonna), bishop's weed (Ammi visnaga), bringaraj (Eclipta alba.), cinchona (Cinchona sp.) coleus (Coleus forskholli), dioscorea, (Dioscorea), glory lily (Gloriosa superba), ipecae (Cephaelis ipecauanha), long pepper (Poper longum), prim rose (Oenothera lamarekiana), roselle (Hibiscus sabdariffa), sarpagandha (Rauvalfia serpentine) senna (Cassia angustifolia), sweet flag (Acorus calamus), or valeriana (Valeriana wallaichii).

Aromatic crops may include ambrette (Abelmoschus moschatus), celery (Apium graveolens), citronella (Cymbopogon winterianus), geranium (Pelargonium graveolens.), Jasmine (Jasminum grantiflorum), khus (Vetiveria zizanoids), lavender (Lavendula sp.) lemon grass (Cymbopogon flexuosus), mint, palmarosa (Cymbopogon martini), patchouli (Pogostemon cablin), sandal wood (Santalum album), sacred basil (Ocimum sanctum), or Tuberose (Polianthus tuberosa). Food crops are harvested for human consumption and feed crops are harvested for livestock consumption. Forage crops may include crops that animals feed on directly or that may be cut and fed to livestock.

Nutrient digestibility is the amount of nutrients absorbed by the individual or animal and is generally calculated as the amount of nutrients consumed minus the amount of nutrients retained in the feces. The incorporation of enzymes into dairy and beef rations has yielded mixed results and has primarily been focused on amylase in cattle. The incorporation of amylase into dairy and beef rations has been shown to increase milk to feed conversions by twelve percent when 15,000 kilo novo units (KNUs) were supplied in a starch rich ration. In ruminants, the addition of 12,000 KNUs of exogenous amylase improved the daily rate of gain by eight percent. The direct influence of amylase of milk yield and components is mixed with increases in milk and milk components reported by few authors. Consistently across trials the addition of amylase has been reported to improve nutrient digestibility and feed use efficiency. The use of enzymes produced during the germination process of cereal grains has long been used in application for the malting industry, the process of leveraging enzymes produced during the optimized hydroponic germination of seeds has yet to be implemented in the feed industry to improve the fertility rates, postpartum energy balance, and support the development of reproductive structures within the animal.

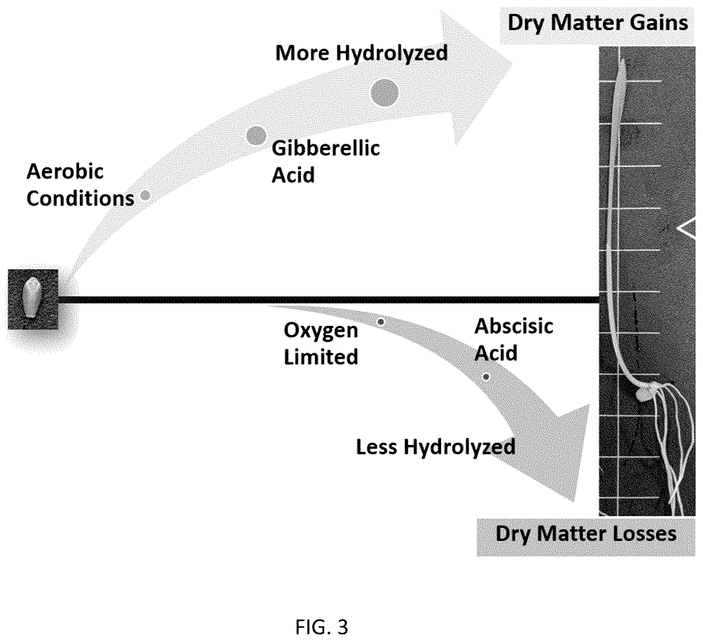

Plant growth and the production of enzymes are greatly affected by the environment. Most plant problems, such as decreased nutrient digestibility, are caused by environmental stresses due to environmental conditions. Environmental factors such as water, humidity, nutrition, light, temperature, and level of oxygen present can affect a plant's growth and development as shown in FIGS. 3-5.

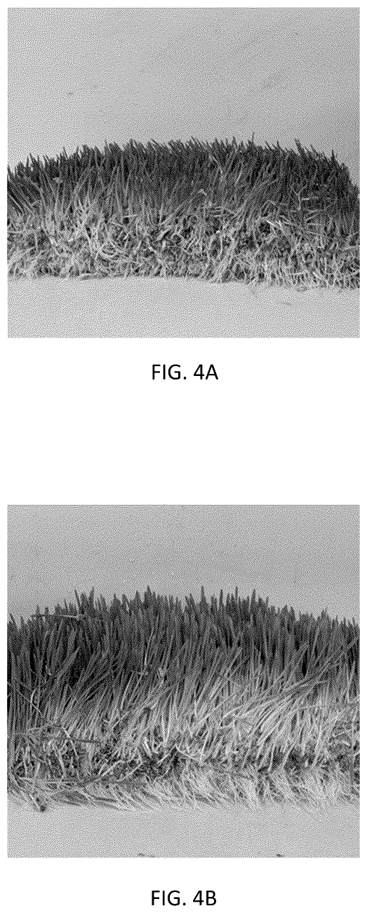

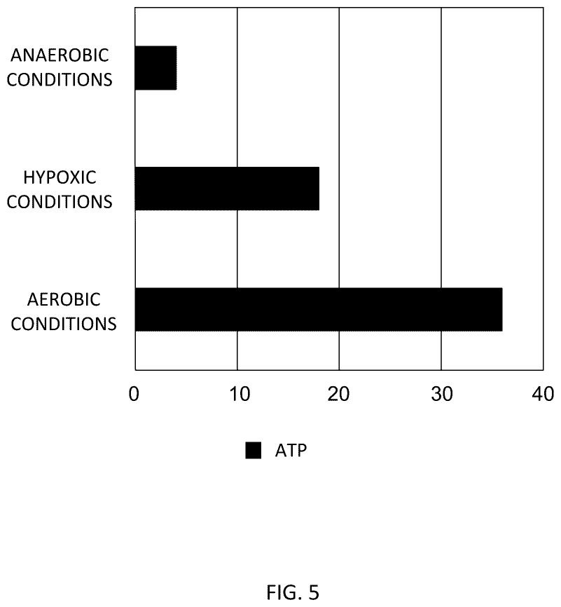

Oxygen is a necessary component in many plant processes included respiration and nutrient movement from the soil into the roots. The amount of oxygen can influence the efficiency of respiration. Oxygen moves passively into the plant through diffusion. Plants may be affected by growing in anaerobic conditions, where the uptake or disappearance of oxygen is greater than its production by photosynthesis or diffusion by physical transport from the surrounding environment. Anaerobic conditions can cause nutrient deficiencies or toxicities within the plant, root or plant death, or reduced growth of the plant. Anaerobic conditions may be caused by a decrease in the amount of oxygen in the air, such as growing a plant or seed in a room without air or oxygen circulation. However, oxygen bound in compounds such as nitrate (NO₃), nitrite (NO₂), and sulfites (SO₃) may still be present in the environment. Waterlogging, where excess water is present in the root zone of the plant or in the soil, inhibits gaseous exchange with the air and can also cause anaerobic conditions. Hypoxic conditions arise when there is insufficient oxygen in a plant's environment and the plant must adapt its growth and metabolism accordingly. Excessive watering or waterlogged soil can cause hypoxic conditions. When anaerobic or hypoxic conditions persist, the microbial, fungal and plant activities quickly use up any remaining oxygen. The plant becomes stressed due to the lack of nutrient uptake by the roots, the plant stomata begin to close, and photosynthesis is reduced. A prolonged period of oxygen deficiency can lead to reduced yields, root dieback, plant death, or greater susceptibility to disease and pests as shown in FIG. 4A. Under aerobic conditions plant growth can thrive, as shown in FIG. 4B. Aerobic conditions are when there is enough oxygen molecules or compounds and energy present to carry out oxidative reactions including nutrient cycling, as shown in FIG. 5.

Light is a necessary component for plant growth and the increase in the production of enzymes, sugars and starches that increase nutrient digestibility. The more light a plant receives, the greater its capacity for producing food and energy via photosynthesis. The energy can be used to produce or increase the expression of enzymes that increase nutrient digestibility. Temperature influences most plant processes, including photosynthesis, transpiration, respiration, germination, and flowering. As temperature increases up to a certain point, photosynthesis, transpiration, and respiration increase. When the temperature is too low or exceeds the maximum point photosynthesis, transpiration, and respiration decrease. When combined with day-length, temperature also affects the change from vegetative to reproductive growth. The temperature for germination may vary by plant species. Generally, cool-season crops (e.g., spinach, radish, and lettuce) germinate between 55° to 65° F., while warm-season crops (e.g., tomato, petunia, and lobelia) germinate between at 65° to 75° F. Low temperatures reduce energy use and increase simple sugar storage whereas adverse temperatures, however, cause stunted growth and poor-quality plants.

Water and humidity play an important role in increasing nutrient digestibility. Most growing plants contain ninety percent water, Water is the primary component of photosynthesis and respiration. Water is also responsible for the turgor pressure needed to maintain cell shape and ensure cell growth. Water acts as a solvent for minerals and carbohydrates moving through the plant, acts as a medium for some plant biochemical reactions, increases enzyme production and expression, and cools the plant as it evaporates during transpiration. Water can regulate stomatal opening and closing thereby controlling transpiration and photosynthesis and is a source of pressure for moving roots through a growing medium such as soil. Humidity is the ratio of water vapor in the air to the amount of water the air can hold at the current temperature and pressure. Warm air can hold more water vapor than cold air. Water vapor moves from an area of high humidity to an area of low humidity. Water vapor moves faster if there is a greater difference between the area of high humidity and the area of low humidity. When the plant's stoma open, water vapor rushes outside the plant into the surrounding air. An area of high humidity forms around the stoma and reduces the difference in humidity between the air spaces inside the plant and the air adjacent to the plant, slowing down transpiration. If air blows the area of high humidity around the plant away, transpiration increases.

Plant nutrition plays an important role in increasing nutrient digestibility. Plant nutrition is the plant's need for and use of basic chemical elements. Plants need at least 17 chemical elements for normal growth. Carbon, hydrogen, and oxygen can be found in the air or in water. The macronutrients, nitrogen, potassium, magnesium, calcium, phosphorus, and sulfur are used in relatively large amounts by plants. Nitrogen plays a fundamental role in energy metabolism, protein synthesis, and is directly related to plant growth. It is indispensable for photosynthesis activity and chlorophyll formation. It promotes cellular multiplication. A nitrogen deficiency results in a loss of vigor and color. Growth becomes slow and leaves fall off, starting at the bottom of the plant. Calcium attaches to the walls of plant tissues, stabilizing the cell wall and favoring cell wall formation. Calcium aids in cell growth, cell development and improves plant vigor by activating the formation of roots and their growth. Calcium stabilizes and regulates several different processes. Magnesium is essential for photosynthesis and promotes the absorption and transportation of phosphorus. It contributes to the storage of sugars within the plant. Magnesium performs the function of an enzyme activator. Sulfur is necessary for performing photosynthesis and intervenes in protein synthesis and tissue formation.

The plant micronutrients or trace elements, iron, zinc, molybdenum, manganese, boron, copper, cobalt, and chlorine, are used by the plant in smaller amounts. Macronutrients and micronutrients can be dissolved by water and then absorbed by a plant's roots. A shortage in any of them leads to deficiencies, with different adverse effects on the plant's general state, depending upon which nutrient is missing and to what degree. Fertilization may affect nutrient digestibility.

Fertilization is when nutrients are added to the environment around a plant. Fertilizers can be added to the water or a plant's growing surface, such as soil. Additional micronutrients and macronutrients can be added to the plant by the grower system.

Plant growth can be split into four growing stages: imbibition, plateau, germination, and seedling. Imbibition is the uptake of water by a dry seed. As the seed intakes the water, the seed expands, enzymes and food supplies become hydrated. The enzymes become active, and the seed increases its metabolic activity. During imbibition the relative humidity is high and may range from 90% to 98% relative humidity. The temperature may range from 76° F. to 82° F. or 22° C. to 28° C. Air movement is minimal. The imbibition may last 18 to 24 hours. The plateau stage is where water uptake increases very little. The plateau stage is associated with hormone metabolism such as abscisic acid (ABA) and gibberellic acid (GA) synthesis or deactivation. During the plateau stage humidity and temperature may be lower than the imbibition stage. Relative humidity may range from 70% to 90% and the temperature may range from 72° F. to 77° F. or 22° C. to 26° C. Air movement may still be minimal. The plateau stage may last 18-24 hours. Germination is the sprouting of a seed, spore, or other reproductive body. The absorption of water, temperature, oxygen availability and light exposure may operate in initiating the process. During germination, the relative humidity may be lower than the imbibition and plateau stage. Relative humidity may range from 60% to 70%. The temperature may be the same as the plateau stage and range from 72° F. to 77° F. or 22° C. to 26° C. Air movement may be moderate. Germination may last 24 to 48 hours. The last phase is the seedling or plant development phase where the plant's roots develop and spread, nutrients are absorbed fueling the plants rapid growth. The seedling stage may last until the plant matures. The seedling stage may also be broken down into additional phases: seedling, budding, flowering and ripening. The relative humidity may be lowest at this stage and range from 40% to 60%. The temperature may also be the lowest at this stage and range from 68° F. to 72° F. or 20° C. to 22° C. Air movement is high. The seedling phase can range from 72 hours or until the plant reaches maturity. The specific control of temperature encourages maximum enzyme hydrolysis throughout development while potentially discouraging the cellular division near the onset of photosynthesis. Temperatures near the cardinal range of seeds is believed to support maximum enzyme hydrolysis approximately through the first 120 hours. Reducing temperatures below the cardinal value at 120 hours is believed to reduce metabolic activity in tissue readily exposed to the environment while having reduced influence on the seed within the cellulosic material layer.

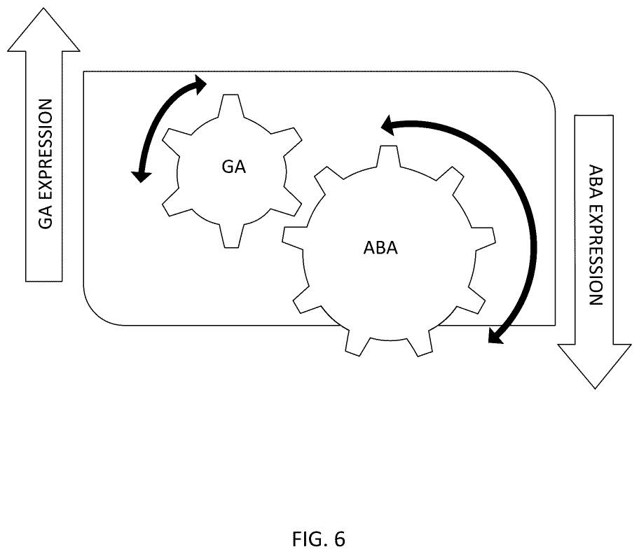

Phytohormones, such as abscisic acid (ABA), GA and ethylene (ET) regulate seed dormancy and seed germination as well as balance or dictate enzyme production. The ratio of ABA and GA regulates seed dormancy. When levels of ABA are high, stomatal closure, stress signaling and delay in cell division is triggered down regulating metabolic and enzyme activity. High ABA/GA ratios favor dormancy, whereas low ABA/GA ratios result in seed germination. The increase in GA is necessary for seed germination to occur, as GA expression increases, ABA expression decreases, as shown in FIG. 6. GA triggers cell division, stem elongation and root development. Enzyme expression is closely linked to metabolic needs during germination. As the plant becomes metabolically active shortly after imbibition, GA is released from the seed embryo signaling the release of a wide profile of enzymes from within the seed including from the aleurone layer surrounding the polysaccharide and protein rich endosperm of the seed. During germination, GA translocates to and interacts with the aleurone layer, thereby releasing or synthesizing hydrolytic enzymes, included a-amylase. The term “amylase” means an enzyme that hydrolyzes 1,4-alpha-glucosidic linkages in oligosaccharides and polysaccharides, including the following classes of enzymes: alpha-amylase, beta-amylase, glucoamylase, and alpha-glucosidase.

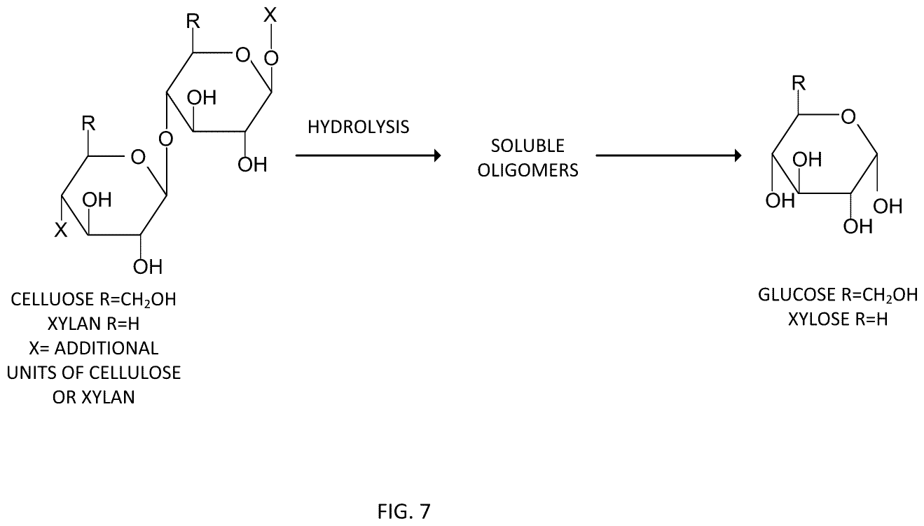

Hydrolytic enzymes are some of the most energy efficient enzymes. The hydrolytic enzymes, such as 1,3;1,4-β-glucanase (β-glucanase), α-amylase and β-amylase, are released. The term “beta-glucosidase” means a beta-D-glucoside glucohydrolase that catalyzes the hydrolysis of terminal non-reducing beta D-glucose residues with the release of beta-D-glucose. Once the hydrolytic enzymes are released, they facilitate the hydrolysis of complex storage molecules including cell wall polysaccharides, proteases, storage proteins, and starchy energy reserves that are essential for germination, providing sugars that drive the root growth, into their simpler monomer subunits. Hydrolysis of the storage molecules is one of the primary energy sources of plants. Hydrolysis of storage molecules into their simpler monomer subunits, increases the rate at which the ruminant can digest the feed and utilize the feed for energy, thereby increasing feed efficiency. The hydrolytic enzymes break the polymers into dimers or soluble oligomers and then into monomers by water splitting the chemical bonds, as shown in FIG. 7.

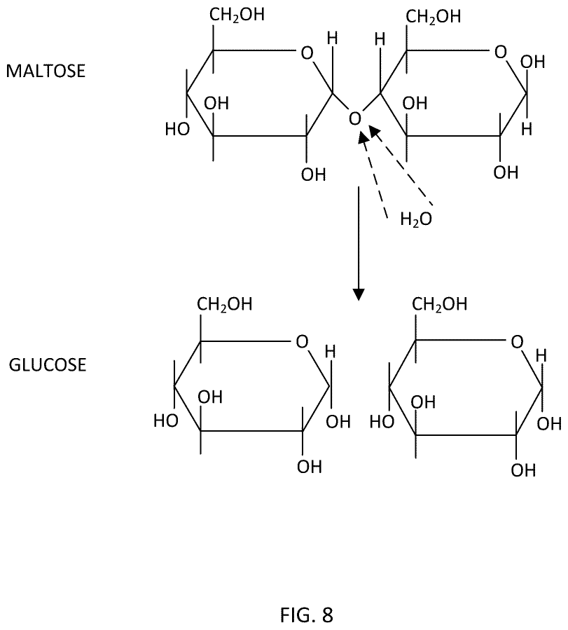

β-glucanase may hydrolyze 1,3;1,4-β-glucan, a predominant cell wall polysaccharide. The α-amylase cleaves internal amylose and amylopectin residues. The β-amylase exo-hydrolase liberates maltose and glucose from the starch molecules as shown in FIG. 8. These reduced nutrient forms are commonly then transported back to the embryo where glycolysis and the cellular respiration pathway uses glucose to produce ATP needed for energy intensive cellular division and biosynthesis reactions. As the metabolic needs of the juvenile plant increases, the release of GA from the seed embryo and the release of enzymes from the aleurone layer likewise increases. Enzyme activity within the juvenile plant peaks at the onset of efficient photosynthesis. At this point, the total metabolic demands of the plant are not able to be met by photosynthesis and a large amount of storage molecules must be hydrolyzed to glucose for glycolysis and ATP generation.

Most mammals have a hard time digesting dietary fibers including cellulose. Cellulose polysaccharides are the prominent biomass of the primary cell wall, followed by hemicellulose and pectin. Cellulosic material is any material containing cellulose. The secondary cell wall, produced after the cell has stopped growing, also contains polysaccharides and is strengthened by polymeric lignin covalently cross-linked to hemicellulose. Cellulose is a homopolymer of anhydrocellobiose and is a linear beta-(1-4)-D-glucan. Hemicellulose can include a variety of compounds, such as, Xylans, Xyloglucans, arabinoxylans, and mannans in complex branched structures with a spectrum of Substituents. Cellulose, although polymorphous, is primarily found as an insoluble crystalline matrix of parallel glucan chains. Hemicellulose usually hydrogen bonds to cellulose as well as other hemicelluloses, stabilizing the cell wall matrix. Cellulolytic enzymes or cellulase mean one or more enzymes that hydrolyze a cellulosic material. The enzymes may include endoglucanase(s), cellobiohydrolase(s), beta-glucosidase(s), or combinations thereof. The enzymes break the cellulosic material down into cellodextrins or completely into glucose. Hemmicellulolytic enzyme or hemicullase are one or more enzymes that hydrolyze a hemicellulosic material forming furfural or arabinose and xylose. When a ruminant digests the feed with the hydrolyzed hemicellulosis material, energy utilization is more efficient, hydrogen dioxide formation is reduced increasing feed efficiency, and gluconeogenesis rates are improved thereby improving energy balance and the development of reproductive structures.

Beta-xylosidase, or beta-D-xyloside xylohydrolase, catalyzes the exo-hydrolysis of short beta (1->4)-xylooligosaccharides to remove successive d-xylose residues from non-reducing termini and may hydrolyze xylobiose. Beta-xylosidase engage in the final breakdown of hemicelluloses. The term “xylanase” means a 1,4-beta D-xylan-Xylohydrolase that catalyzes the endohydrolysis of 1,4-beta-D-Xylosidic linkages in Xylans. The term “endoglucanase” means an endo-1,4-(1,3:1,4)-beta-D-glucan 4-glucanohydrolase that catalyzes endohydrolysis of 1,4-beta-Dglycosidic linkages in cellulose, cellulose derivatives (such as carboxymethyl cellulose and hydroxyethyl cellulose), lichenin, beta-1,4 bonds in mixed beta-1,3 glucans such as cereal beta-D- glucans or Xyloglucans, and other plant material containing cellulosic components.

Lignin is another primary component of the cell wall. Lignin is a class of complex polymers that form key structural materials in support tissues, such as the primary cell wall, in most plants. The lignols that crosslink to form lignins are of three main types, all derived from phenylpropane: coniferyl alcohol (4-hydroxy-3-methoxyphenylpropane), sinapyl alcohol (3,5-dimethoxy-4-hydroxyphenylpropane), and paracoumaryl alcohol (4-hydroxyphenylpropane. Lignin fills the spaces in the cell wall between cellulose, hemicellulose, and pectin components. It can covalently crosslink to hemicellulose mechanically strengthening the cell wall. Ligninolytic enzymes are enzymes that hydrolyze lignin polymers. The ligninolytic enzymes include lignin peroxidases, manganese peroxidases, laccases and feruloyl esterases, and other enzymes described in the art known to depolymerize or otherwise break lignin polymers. Also included are enzymes capable of hydrolyzing bonds formed between hemicellulosic Sugars (notably arabinose) and lignin.

Lipids are used as structural components to limit water loss and pathogen infection. These lipids include waxes derived from fatty acids, as well as cutin and Suberin. Lipase is an enzyme that hydrolyzes lipids, fatty acids, and acylglycerides, including phosphoglycerides, lipoproteins, diacylglycerols, and the like. Lipases include the following classes of enzymes: triacylglycerol lipase, phospholipase A2, lysophospholipase, acylglycerol lipase, galactolipase, phospholipase A1, dihydrocoumarin lipase, 2-acetyl-1-alkylglycerophosphocholine esterase, phosphatidylinositol deacylase, cutinase, phospholipase C, phospholipase D, 1-hosphatidylinositol phosphodiesterase, and alkylglycerophospho ethanolamine phosphdiesterase. Lipase increases the digestibility of lipids by breaking lipids down digestibly into saccharides, disaccharides, and monomers.

Phytate is the main storage form of phosphorous in plants. However, many animals have trouble digesting or are unable to digest enzymes because they lack enzymes that break phytate down. Because phosphorus is an essential element, inorganic phosphorous is usually added to animal feed. Phytase is a hydrolytic enzyme that specifically acts on phytate, breaking it down and releasing organic phosphorous. The term “phytase” means an enzyme that hydrolyzes ester bonds within myo-inositol-hexakisphosphate or phytin, including 4-phytase, 3-phytase, and 5-phytase. By increasing the activity of the hydrolytic enzymes, organic phosphorous is released and inorganic phosphorous does not have to be added to animal feed.

Protease breaks down proteins and other moieties, such as sugars, into smaller polypeptides and single amino acids by hydrolyzing the peptide bonds. Many of the proteins serve as storage proteins. Some specific types of proteases include cysteine proteases including pepsin, papain and serine proteases including chymotrypsins, carboxypeptidases and metalloen dopeptidases. Proteases play a key role in germinations through the hydrolysis and mobilization of proteins that have accumulated in the seed. Proteases also play a role in programmed cell death, senescence, abscission, fruit ripening, plant growth, and N homeostasis. In response to abiotic and biotic stresses, proteases are involved in nutrient remobilization of leaf and root protein degradation to improve yield.

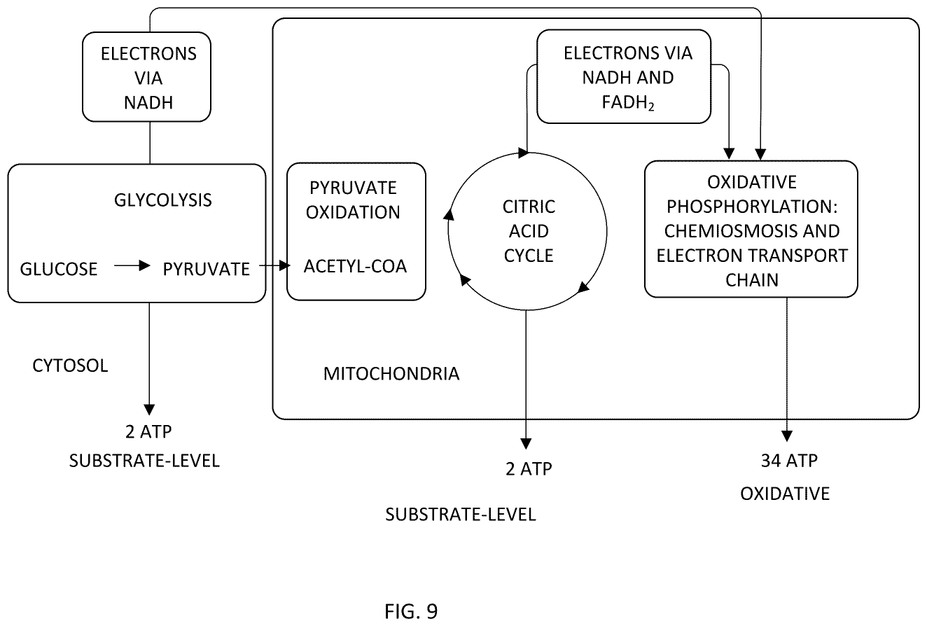

Cellular respiration is a set of metabolic reactions that take place in the cells of the seed to convert chemical energy from oxygen molecules or nutrients into adenosine triphosphate (ATP), as shown in FIG. 9. Nutrients, such as sugar, amino acids and fatty acids are used during cellular respiration. Oxygen is the most common oxidizing agent. Aerobic respiration requires oxygen to create ATP and is the preferred method of pyruvate in the breakdown into glycolysis. The energy transferred is used to break bonds in adenosine diphosphate (ADP) to add a third phosphate group to form ATP by phosphorylation, nicotinamide adenine dinucleotide (NADH) and flavin adenine dinucleotide (FADH₂). NADH and FADH₂is converted to ATP using the electron transport chain with oxygen and hydrogen being the terminal electron acceptors. Most of the ATP produced during aerobic cellular respiration is made by oxidative phosphorylation. Oxygen releases chemical energy which pumps protons across a membrane creating a chemiosmotic potential to drive ATP synthase.

By decreasing environmental stresses and increasing metabolic activity, the plant can be harvested in an interval that closely aligns with the maximum point of enzyme activity within the plant's life cycle and increased development results. The harvested product is rich in enzymes. Based on enzyme values reported when investigating the malting characteristics of cereals, barley is estimated to have approximately 12,000 kilo novo units (KNO) of amylase activity per kg dry matter, 400 units of protease per milligram protein and 200 units of lipase per milligram protein. Wheat is expected to have amylase levels approximately 50% to 75% the amount of barley on average with lipase and protease values equal and 100% greater, respectively. Enzymes, such as peroxidase and hemicellulose, relating to fiber catabolism are likely also very active due to the decrease in environmental stresses.

For example, barley harvested at the maximum point of enzyme activity, the amount of crude protein increases. Crude protein is the content of the animal feed or plant sample that represents the total nitrogen, including true protein and non-protein nitrogen (urea and ammonia). Crude protein is an important indicator of the protein content of a forage crop. In one example the crude protein in barley can be increased by 143% instead of 117% and 125% when harvested on day six, when enzyme activity was maximized. In another example, wheat is harvested at the maximum enzyme point, such as day six, the amount of crude protein can be increased by 129%. The neutral detergent fiber (NDF) of a crop, plant, or feed sample content is a close estimate of the total fiber constituents of the crop. The NDF contains plant cell wall components such as cellulose, hemicellulose, lignin, silica, tannins, and cutins, it does not include some pectins. The structural carbohydrates, hemicellulose, cellulose, and lignin, represent the fibrous bulk of the crop. Though lignin is indigestible, hemicellulose and cellulose can be (in varying degrees) digested by microorganisms in animals with either a rumen, such as cattle, goats or sheep, or hind-gut fermentation such as horses, rabbits, guinea pigs, as part of their digestive tract. NDF is considered to be negatively correlated with dry matter intake, as when the percentage of NDF increases the animals consume less of the crop. In one example the NDF in barley can be increased by 178% instead of by 132% and 155% when harvested on day six when enzyme activity is maximized. In another example, when wheat is harvested at the maximum enzyme point, such as day six, the amount of NDF can be increased by 173%. Water-soluble carbohydrates (WSC) are carbohydrates that can be solubilized and extracted in water. WSC's can include monosaccharides, disaccharides and a few short chain polysaccharides, such as fructans, which are major storage carbohydrates.

In one example the WSC in barley increased by 442% instead of by 182% and 191% when harvested on day six when enzyme activity was maximized. In another example, when wheat is harvested at the maximum enzyme point, such as day six, the amount of WSC can be increased by 553%. The increase in percentage is evidence that by increasing the enzyme activity in plants, complex storage molecules are being broken down into simpler monomer storage molecules increasing nutrient digestibility. Starch is an intracellular carbohydrate found primarily in the grain, seed, or root portions of a plant as a readily available source of energy, In crops where GA activity increases, the amount of starch present in the feed is reduced. This may be due to the breakdown of starch into simpler sugars, such as glucose and maltose, by the enzymes increasing nutrient digestibility of the feed. When enzyme activity is maximized, the amount of starch in barley can be increased by 17% and by 26% in wheat. Dry matter refers to all the plant material excluding water. The nutrient or mineral content of animal feed or plant tissues may be expressed on a dry matter basis or the proportion of the total dry matter in the material. When enzyme activity is maximized the dry matter ratio can increase, such as by 118% in barley and 115% in wheat, instead of by 92% or 95%.

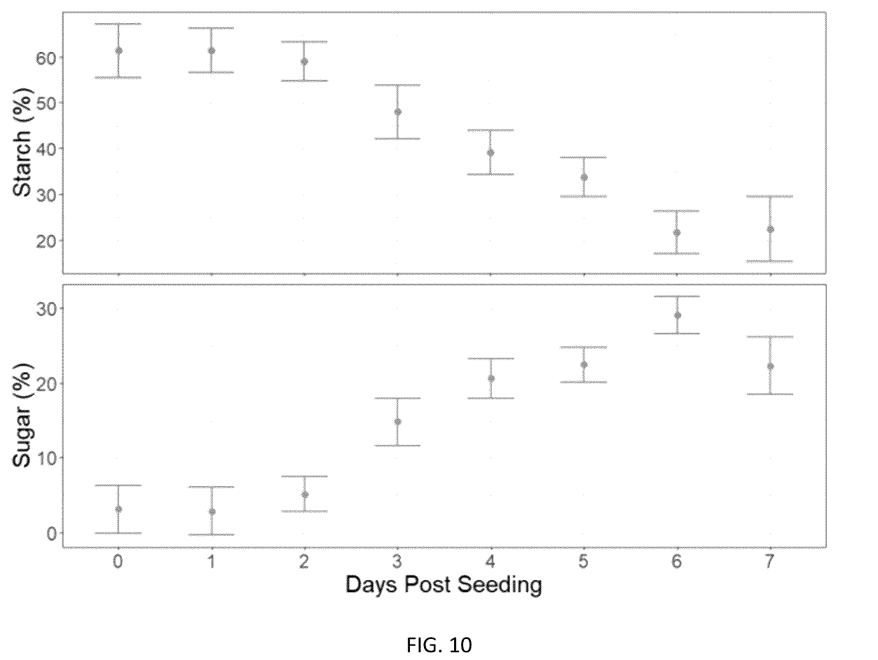

In yet another example, when the enzyme activity is maximized the amount of starch in the hydroponically sprouted grains may decrease in percentage, such as from 60% to 20% or 30%. By utilizing the enzymes in the hydroponically sprouted grain, starch decreases and nutrient digestible sugars increase, for example from 5% to 20% or 30% or even higher, as shown in FIG. 10.

The breakdown of storage molecules into nutrient digestible monomer subunits can be increased by leveraging GA in a hydroponic environment. When GA activity is increased in crops, the crude protein content can increase, such as from 15.9% to 20.4% in rye. When ABA activity is increased, the crude protein content decreases, for example, from 15.9% to 13.7%. Crude protein content in a crop, plant, or feed sample represents the total amount in nitrogen in the diet, including protein and non-protein nitrogen. The fibrous component of a crop, plant or feed sample content represents the least digestible fiber portion. The least digestible portion includes lignin, cellulose, silica, and insoluble forms of nitrogen. Hemicellulose is not included in the least digestible portion. Crops with a higher acid detergent fiber (ADF) have a lower digestible energy. As the ADF level increases, the digestible energy level decreases. When GA activity is increased, the ADF percentage increases, such as from 9.2% to 12.8% in rye. When ABA activity increases, the ADF percentage decreases, such as from 9.2% to 4.2%. In crops where the GA activity increases the percentage of NDF increases, such as from 21.6% to 27.1% in rye. In crops, where ABA activity increases, the NDF percentage decreases, such as from 21.6% to 15.2% in rye. The ethanol soluble carbohydrates (ESC) of a plant include monosaccharides, such as glucose and fructose, and disaccharides. When GA activity increases the ESC percentage decreases slightly, as energy is needed to grow the plant or crops. In rye the ESC percentage may decrease from 35.3% to 31.7% In rye the starch percentage decreased from 19.1% to 9.6%. However, when ABA activity increased due to environmental stressors, the amount of starch in the rye increased from 19.1% to 42.2%. Crude fat is an estimate of the total fat content of the crop or feed sample. Crude fat contains true fat (triglycerides), alcohols, waxes, terpense, steroids, pigments, ester, aldehydes, and other lipids. In feed samples where GA activity was increased due to reducing environmental stresses, the amount of crude fat increases. In rye crops the crude fat may increase from 1.39% to 2.78%. Crude fat also increases when ABA activity increases. In rye crops the crude fat percentage may increase from 1.39 to 1.44%.

The processes, systems, and methods of the present disclosure improve fertility rates in ruminants. The process, systems, and method of the present disclosure provide hydroponically sprouted grains or hydroponically sprouted cereal grains as a sustainable and scalable solution to improve fertility rates and postpartum milk production in ruminants. The processes and methods of the present disclosure increase relative concentration of hexoses and thereby rates of glycolysis through inclusion of hydroponically sprouted grains to reduce dihydrogen concentrations within the rumen. Through increasing relative concentration of hexoses and in turn propionate, gluconeogenesis, and insulin levels, hydroponically sprouted cereal grains may be used as an approach to positively impact not only energy balance, but progesterone profile and ovulation rates. Favoring glycolysis through increased supplementation of hexoses supports increased production of propionate through lactate lowering acetyl-CoA and carbon dioxide pathways.

During the last trimester, a remarkable 70% of total calf birth weight is gained, causing protein and energy requirements to peak. While nutrition needs peak, feeding behavior of transition cows can drop by up to 30%, putting close-up cows at risk of disease, metabolic disorders, and hypocalcemia after calving. Hypocalcemia is a common and dangerous nutrient deficiency for transition cows and can result in risky conditions including dystocia, uterine prolapses, retained membranes, mastitis, displaced abomasum, and overall weak immune status. Overweight cows at calving may develop a fatty liver inhibiting or lowering the rate of glucenogenesis. Therefore, including at least hydroponically sprouted cereal grains increases feed efficiency and nutrient digestibility to maintain a healthy ruminant while increasing fertility rates, maintaining a pregnancy, and increasing postpartum energy balance.

As the ruminant digests the hydroponically sprouted cereal grains, including non-fibrous carbohydrates, the fermentable energy produces the volatile fatty acids acetate, propionate, and butyrate. Acetate, propionate, and butyrate concentrations and relative proportions are dependent on the amount and composition of feed ingested. However, the amount of acetate and butyrate produced is decreased along with the ratio of acetate to propionate. As the main precursor for gluconeogenesis, propionate is involved in energy homeostasis in ruminants. The volatile fatty acids are end products of fermentation of dietary carbohydrates by the anaerobic intestinal microbiota and have multiple effects on mammalian energy metabolism. Circulating volatile fatty acids play a role in the regulation of both fatty acid and glucose metabolism. These metabolic processes are vital to the energy status of an animal and affect many downstream physiological processes.

Ruminal pH is a critical factor in the normal and stable function of the rumen because of its profound effect on microbial populations and fermentation products, and on physiological functions of the rumen, mainly motility and absorptive function. The rumen harbors diverse microorganisms including bacteria, protozoa, fungi, archaea, and viruses. They play a key role in the breakdown and utilization of feedstuff carbohydrate and protein through the process of fermentation, resulting in the production of volatile fatty acids and microbial protein. The increase in propionate increases fertility rates, postpartum energy balance, and maintenance of a healthy pregnancy. Rumen microbes may thrive on glucose, increasing efficiency of the feed composition when glucose is readily available, allowing the ruminant to process the feed composition quicker and increase propionate levels. Microbial protein yield is higher, allowing the microbes to create more protein resulting in a higher microbial biomass. By utilizing hydroponically grown sprouts, ruminants can utilize glucose quicker, more efficient energy utilization, and create more microbial protein while maintaining a consistent pH. As the main precursor for gluconeogenesis, propionate is involved in energy homeostasis in ruminants.

Because fertility is linked with a number of physiological processes including energy metabolism, and insulin sensitivity, it is possible that shifts in nutrition that have occurred to support greater milk production have negatively contributed to reproductive status of dairy cows. However, hydroponically sprouted cereal grains, grown utilizing a grower system, improve fertility rates and conception rates while maintaining or supporting greater postpartum milk production in dairy cows.

As propionate increases, the amount of glucose from gluconeogenesis increases. The increase in glucose may directly increase the levels of insulin circulating and increase the levels of liver IGF1 thereby increasing reproduction rates. The increased release of insulin antagonizes lipolysis and promotes lipogenesis, regulating postpartum NEFA and BHBA. Insulin stimulates the liver to increase or promote the expression of growth hormone receptors and release IGF1 into circulation, regulating the ruminant's reproductive state.

After calving, glucose levels typically drop due to the demand for milk production. By feeding the ruminant a feed composition including at least hydroponically sprouted cereal grains, glucose levels after calving can increase. The increase in glucose levels or the blood concentration of glucose, increase insulin levels. The increase in insulin levels and glucose levels increase the secretion of hypothalamic gonadotropin releasing hormone (GnRH) and luteinizing hormone (LH), which stimulate the ovaries. This stimulation shortens the interval between calving and the first postpartum ovulation. The oocytes depend on glucose for energy.

In a cycling cow, low levels of glucose may affect estradiol production in the follicles and progesterone production in the corpus luteum. Lower circulating estradiol from the preovulatory follicle can lead to abnormal patterns of follicular growth, anovulatory conditions, multiple ovulation, and reduced estrous expression. As glucose and insulin levels increase, the levels of progesterone may increase. Progesterone is responsible for regulating a number of physiological processes related to reproduction including ovulation, implantation, and pregnancy. In dairy cattle, increased plasma progesterone levels have been associated with improved conception rates, maintenance of pregnancy, and postpartum return to cyclicity.

### Exemplary Methods

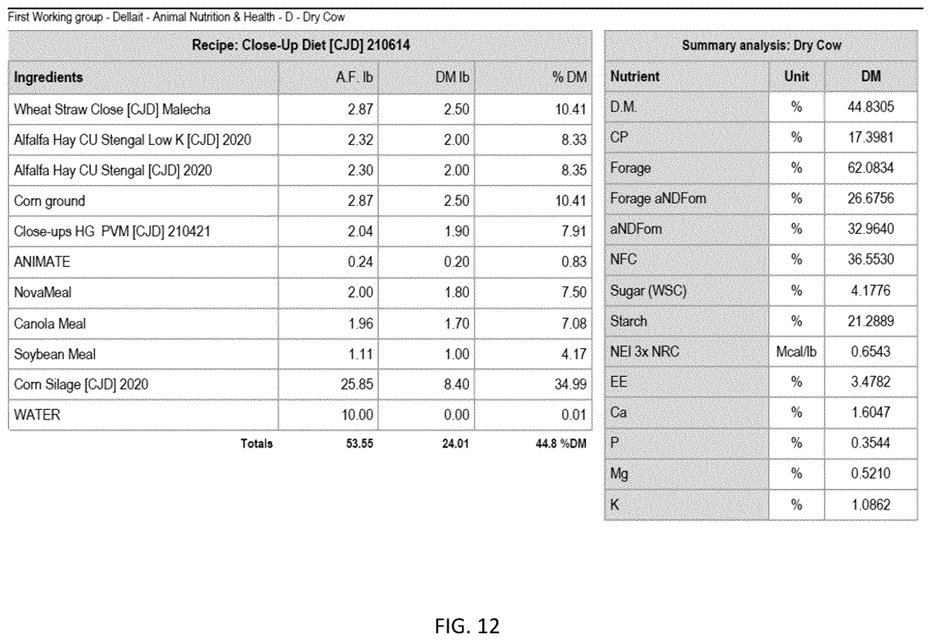

During 2021 the Dellait team conducted an experiment feeding hydroponically grown cereal grains to transition Jersey cows. In 2020 the American Jersey Cattle Association had ranked this farm as first in fat production, third in milk protein, and fourth in milk production. The feed supplement tested included hydroponic grown cereal grains from a fully automated grower system from seeding to harvesting, and re-seeding, grown in an indoor controlled environment in the company's facilities in Sioux Falls, South Dakota. Early feeding observations had suggested hydroponically grown cereal grains may positively influence dry matter intake, rumination activity, and nutrient digestibility. The experimental diets, formulated with and without the hydroponically grown cereal grains, also contained wheat straw, low potassium alfalfa hay, corn grain, anionic salts (ANIMATE), bypass protein (NovaMeal), canola meal, soybean meal, corn silage, and water, as shown in FIG. 12. Milk production assessed daily with GEA milk metering and reported to DC305. Rumination assessed with CowManager sensors. Weekly samples to test total mixed ration (TMR) composition and digestibility were conducted by Rock River Laboratory. Ruminants ate hydroponically grown cereal grains at 1.9 pounds dry matter basis per head per day or 7.9 percent of the total dry matter intake, as shown in FIG. 12. The diet composition are also shown in FIG. 12.

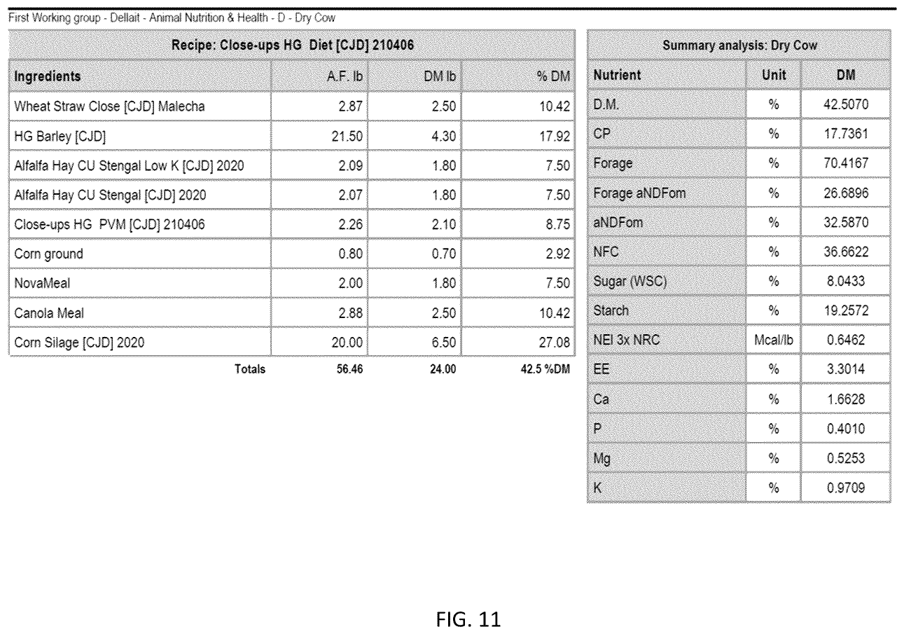

To investigate claims of hydroponically sprouted cereal grains as a sustainable and scalable solution to improve fertility in dairy cattle, two separate crossover type observations were designed. First a crossover observation investigating influence of hydroponically sprouted cereal grains inclusion on periparturient animals approximately 21 days or less prior to calving. In total through the first observation, 742 periparturient animals were administered the hydroponically sprouted cereal grains treatment and compared to a similar group of 783 cattle which were not delivered the treatment. Both hydroponically sprouted cereal grains and control diets were held consistent for metabolizable energy, fiber, such as aNDF, and crude protein, as shown in FIGS. 11 and 12. Dry matter intake, apparent nutrient digestibility, rumination activity, postpartum milk production, and conception rate was evaluated during the observation. Pens were administered dietary treatments ad liberum with dry matter intake and refusal weight recorded daily. Apparent nutrient digestibility was assessed through weekly paired TMR and manure sampling for analysis using the Combs-Goeser in vitro digestion technique (Goeser and Combs, 2009). Individual milk yield was evaluated on a per milking basis (M6700, GEA, Dusseldorf, Germany) and individual milk composition was assessed on a biweekly sampling basis. Daily pen estimates of eating, rumination, chewing, and activity duration were assessed through ear tag sensors (Ear Sensor, CowManager, Harmelen, Netherlands).

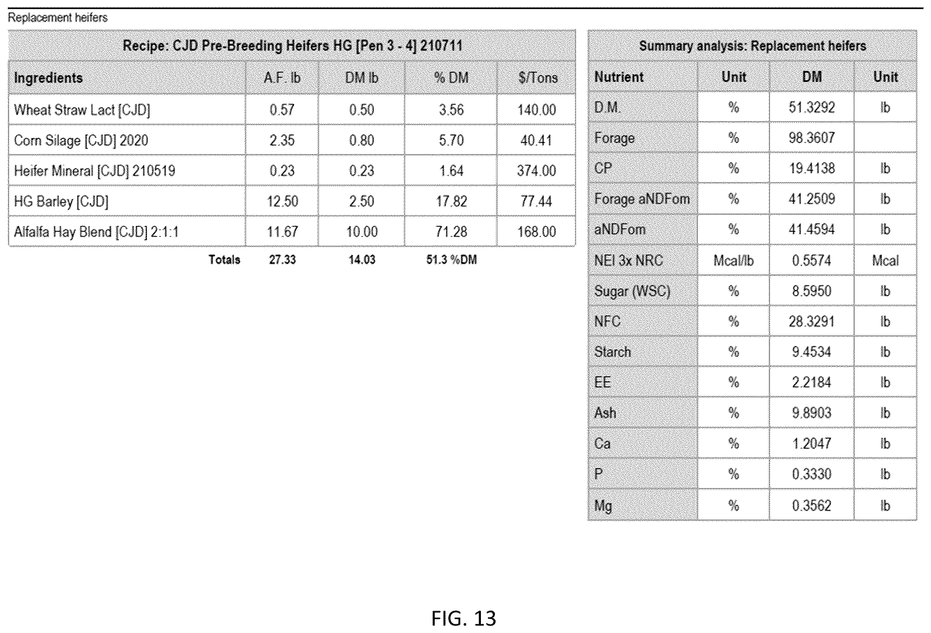

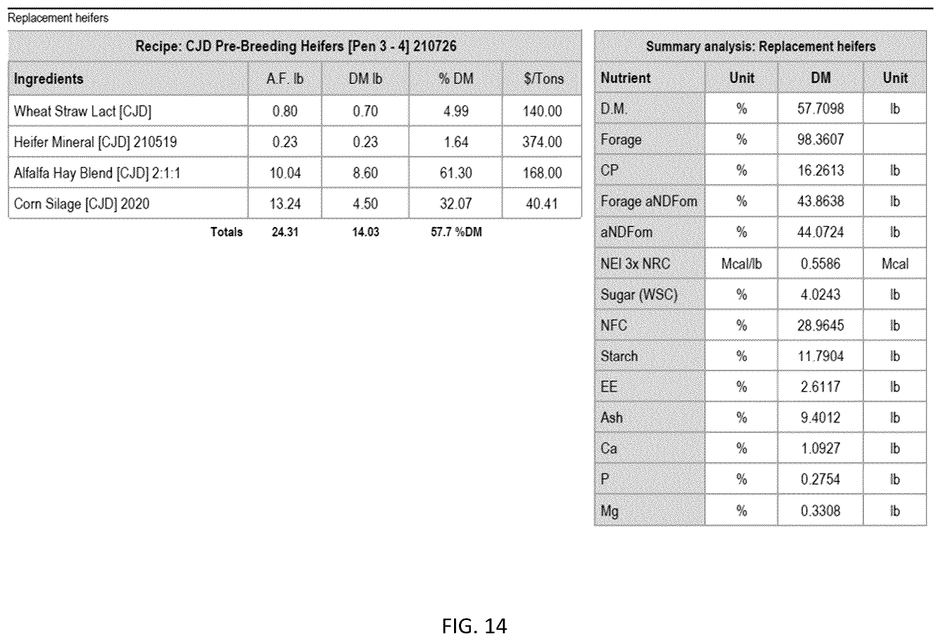

Second, a crossover observation was designed investigating influence of hydroponically sprouted cereal grains inclusion on breeding age heifers approximately 21 days prior to the first artificial insemination. In total through the first observation, 280 breeding age heifers were administered the hydroponically sprouted cereal grains treatment and compared to a similar group of 284 cattle which were not delivered the treatment. Both hydroponically sprouted cereal grains and control diets were held consistent for metabolizable energy, fiber and crude protein FIGS. 13 and 14. Dry matter intake, apparent nutrient digestibility, rumination activity, heat index, estrous patterns, blood serum chemistry and conception rate were evaluated during the observation. Pens were administered dietary treatments ad liberum with dry matter intake and refusal weight recorded daily. Apparent nutrient digestibility was assessed through weekly paired TMR and manure sampling for analysis using the Combs-Goeser in vitro digestion technique (Goeser and Combs, 2009). Daily pen estimates of eating, rumination, chewing, and activity duration were assessed through ear tag sensors (Sense Hub Dairy, Allflex, Cape Town, South Africa).

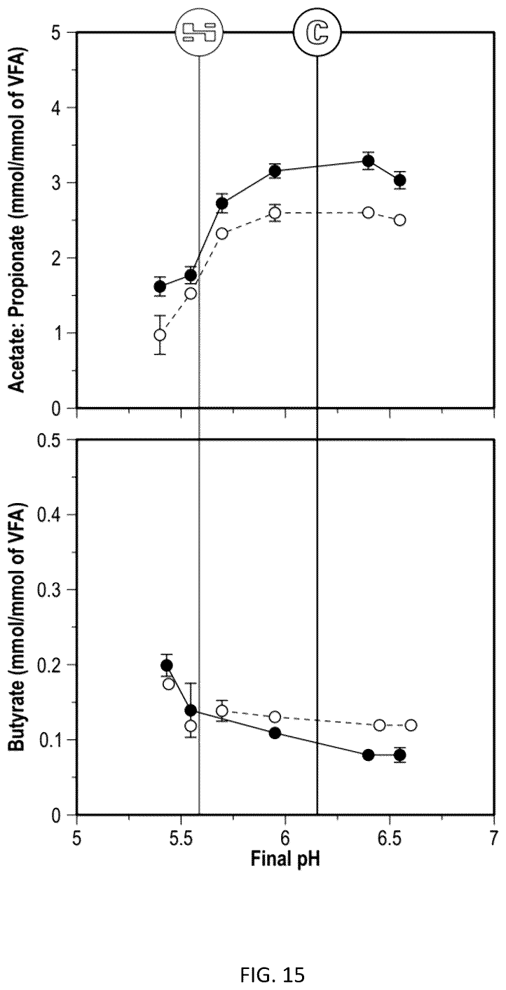

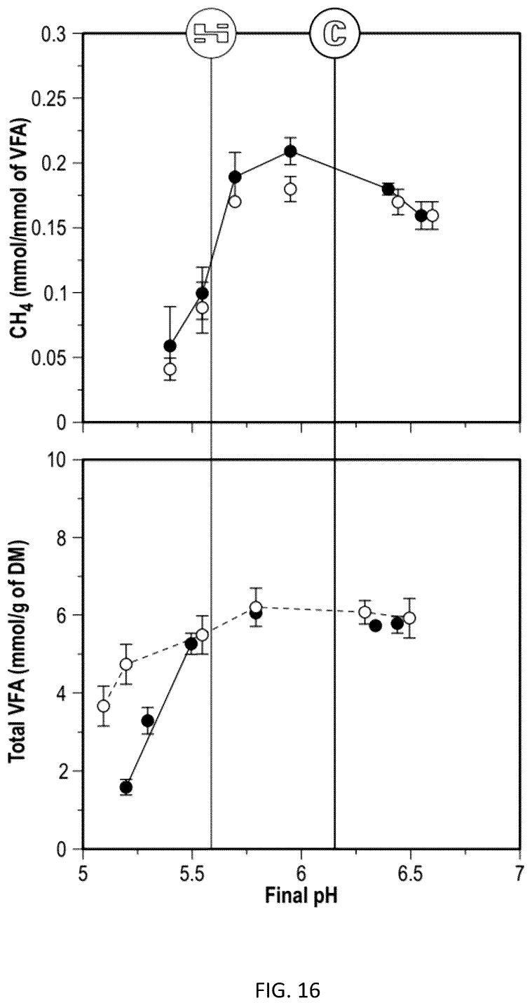

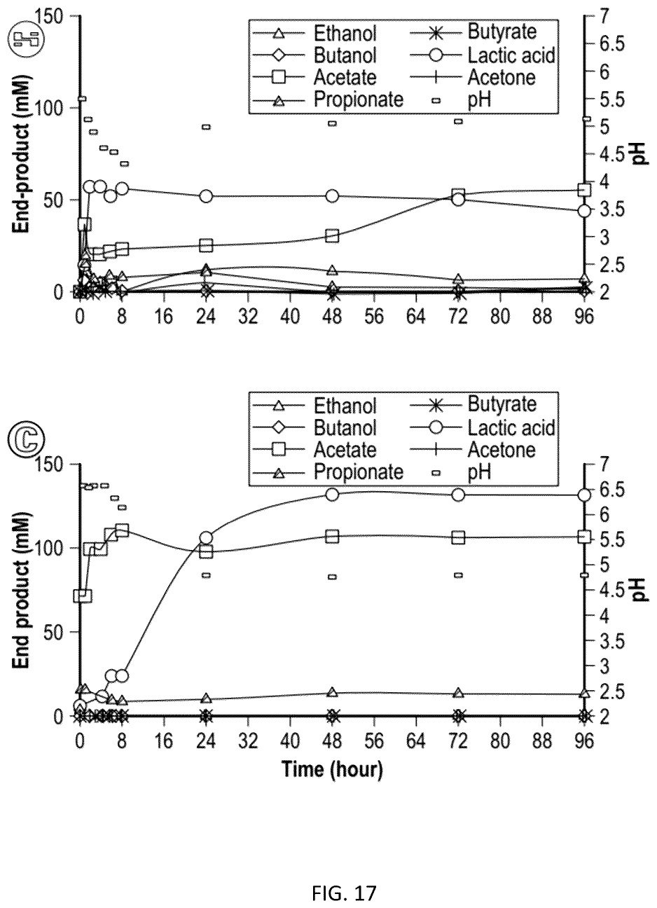

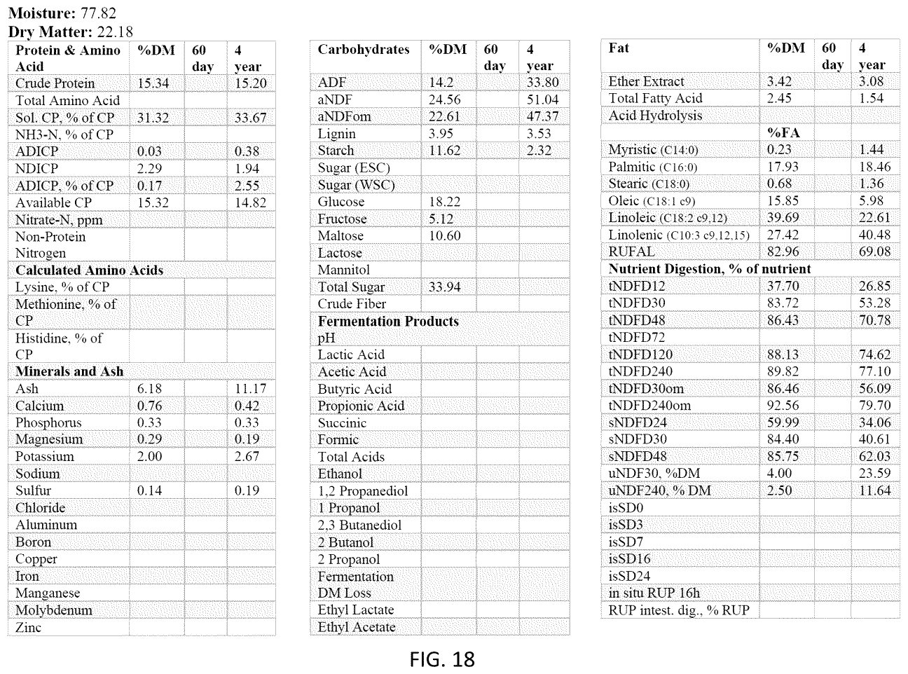

Hydroponically sprouted cereal grains introduced at a 14% dry matter inclusion level thereby altering glucose, propionate, acetate, butyrate, and hexose concentrations as shown in FIGS. 15-17. FIG. 18 illustrates the nutritional breakdown of the hydroponically sprouted grains in accordance with an exemplary aspect of the present disclosure.

Hydroponically sprouted grains may also be introduced at a higher percentage or a lower percentage, such as 10%, 12%, 16% 20%, 25%, or 50%. The percentage of hydroponically sprouted grains may be selected based on the ruminants. In other aspects of the present disclosure, the percentage of hydroponically sprouted grains may increase over a period of time.

### Exemplary Results

The grower systems allow for the production of quality forage under controlled conditions. This system may grow feed using a fraction of the land required by conventional forage production. The same amount of feed is produced year-round, regardless of season or weather, using a fraction of the water used in traditional production systems. Table 1 shows the nutrient composition of the hydroponically grown cereal grains compared with alfalfa hay. Crude protein (CP), sugars, starches, sodium (Na), fibers (ADF and NDF), net energy for lactation (NEL), the total mineral content (Ash), calcium (Ca), phosphorous (P), magnesium (Mg), potassium (K), sulfur (S), and chlorine (Cl). Important nutritional aspects are moderately high crude protein, low fiber, high sugar and starch concentrations, and low potassium.

TABLE 1
Composition of Hydroponically grown cereal grains (HG) and alfalfa hay (AH).

| | | | | NEL | | Starch | | | | | | | | |
|---|---|---|---|---|---|---|---|---|---|---|---|---|---|---|
| | CP | ADF | NDF | (Mcal/lb) | Sugars | (%) | Ash | Ca | P | Mg | K | Na | S | Cl |
| HG | 19.6 | 9.9 | 21.0 | 0.85 | 33.0 | 20.3 | 2.8 | 0.1 | 0.5 | 0.2 | 0.5 | 0.2 | 0.1 | 0.1 |
| AH | 20.8 | 33.4 | 42.9 | 0.65 | 6.9 | 1.4 | 9.4 | 1.4 | 0.3 | 0.3 | 2.5 | 0.2 | 0.3 | 0.6 |

At similar protein content, alfalfa has approximately 3 times more ADF, 2 times more NDF, 5 times more potassium, 4.8 times less sugars and 14.5 times less starch. Since fiber is negatively correlated with energy, the hydroponically grown cereal grains or sprouts may have 30% more energy than alfalfa. The presence of more sugars and starch promotes rumen microbial growth and thus metabolizable protein. Using high quality forages such as high-quality alfalfa during this period is not recommended since it can contain roughly 2-3 percent potassium and increase the overall concentration of this mineral in the diet. It has been reported that reducing the potassium concentration to 1.1 percent of the diet prevents clinical hypocalcemia. The low potassium concentration of hydroponically grown cereal grains helps with the dietary cation anion difference balance, particularly during the close-up period.

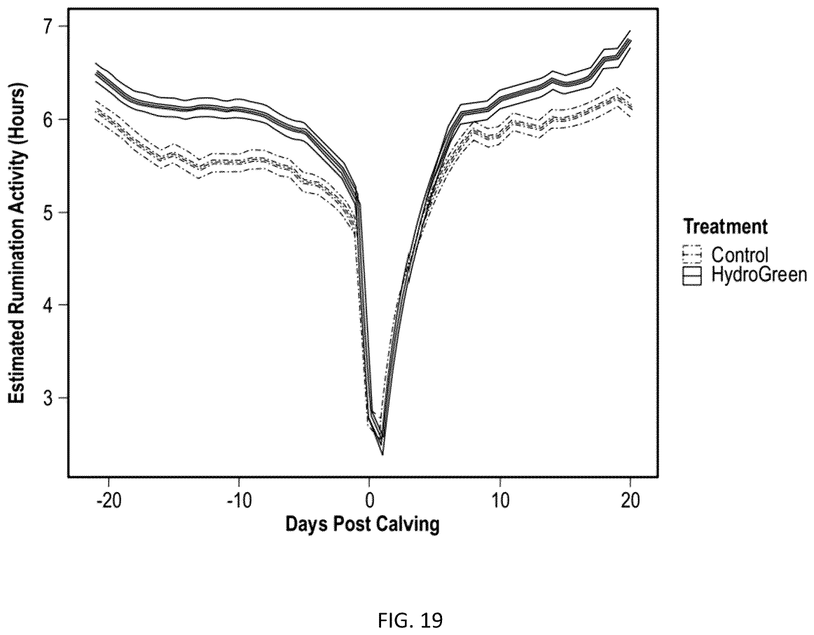

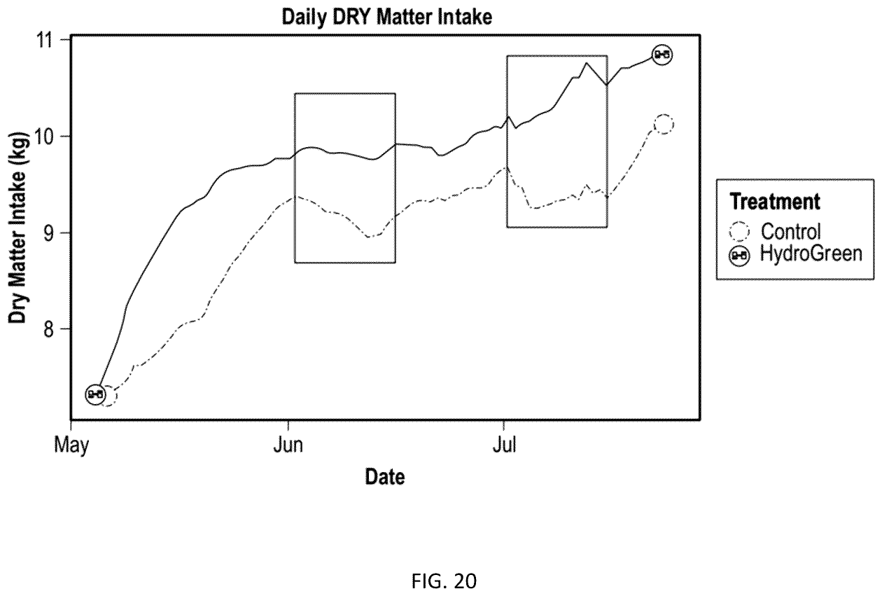

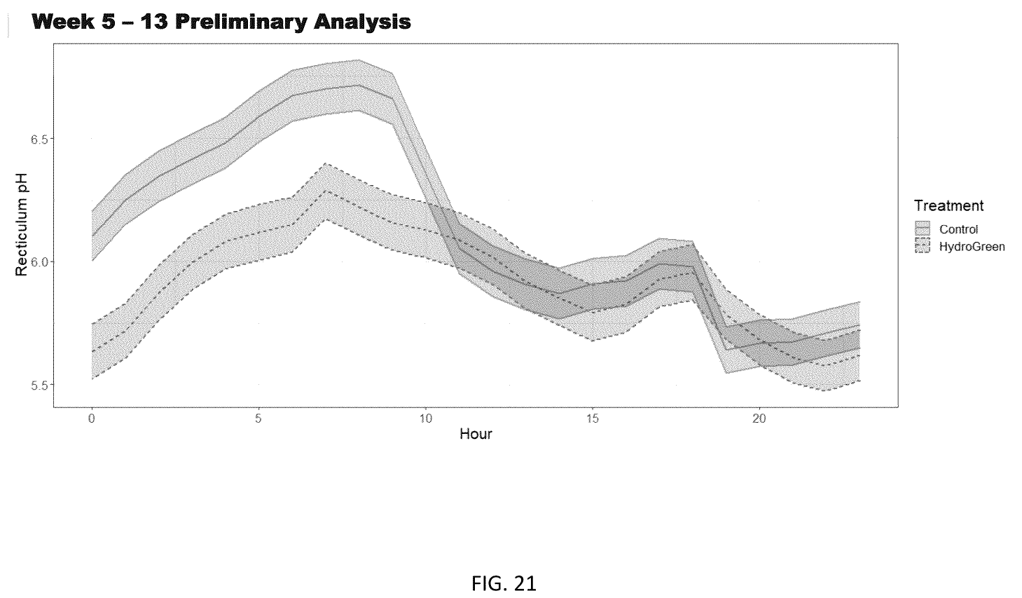

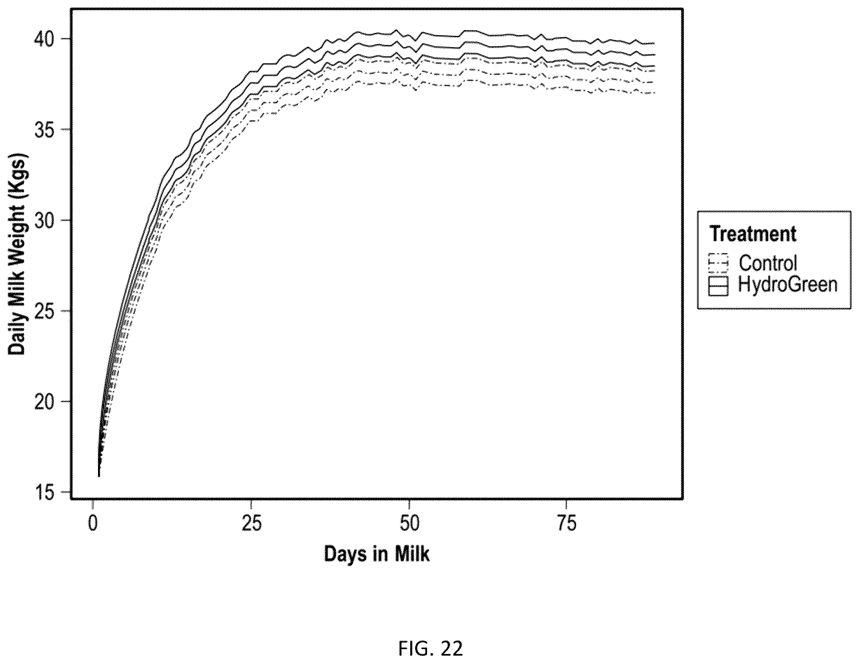

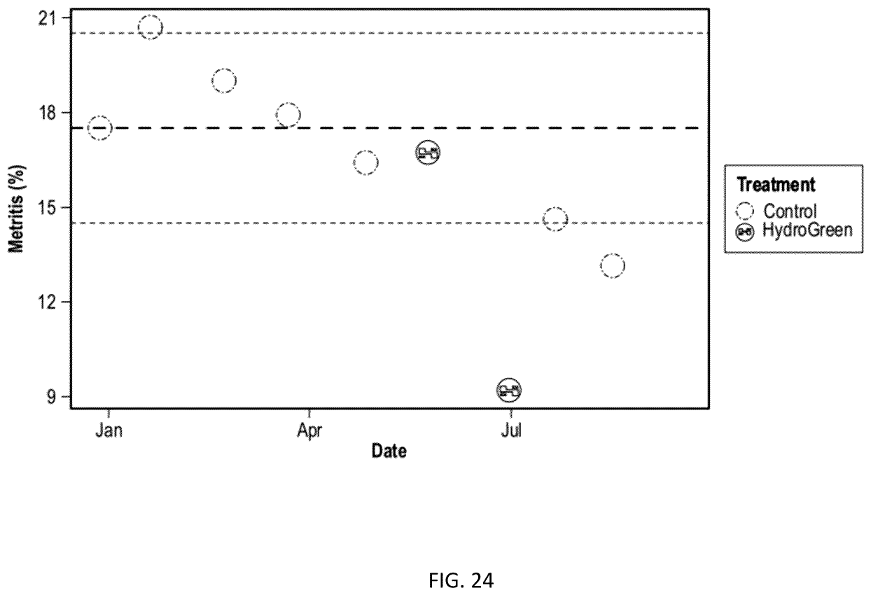

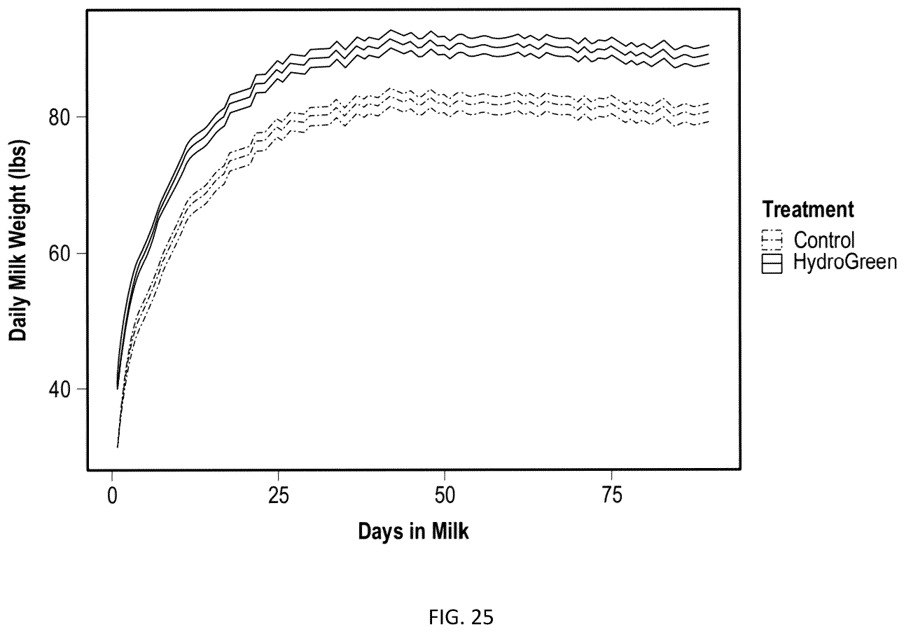

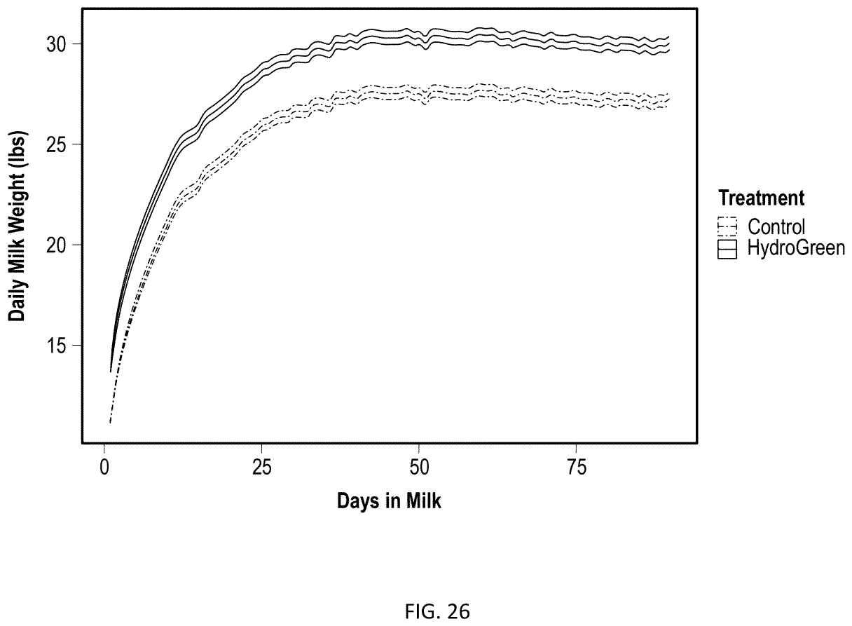

Values reported in the periparturient observation support the importance of dietary intake of the cow leading up to calving. Dry matter intake and rumination activity was observed to significantly (p<0.01) increase by 12%, as shown in FIG. 19. Increased metabolic intake in the periparturient period, was observed to be translated into highly significant responses in both dry matter intake and milk production (1.5 kg, +5%) postpartum, as shown in FIGS. 19, 20 and 22. Cows fed HydroGreen® as part of their diet had better rumination response both pre and post calving, as shown in FIG. 22. More stabilized pH levels were observed translating to a homeostasis of energy balance, as shown in FIG. 21. Feed efficiency improves and was observed to increase by at least 5%. Fiber digestibility may increase, in some aspects, by at least 10%. Milk weighs per milking and total milk were consistently higher during the first three months of lactation for cows fed hydroponically grown cereal grains both during the close-up period and during milking, as shown in FIGS. 25 and 26. Metritis is also one of the most common ailments to dairy cattle post calving. The incidence of metritis may drop significantly when ruminants are fed hydroponically sprouted cereal grains or a feed composition including hydroponically sprouted cereal grains, as shown in FIG. 24 The cost per case of metritis is estimated to be $358 dollars.

Peak milk was observed to increase on average 1.5 kg postpartum. Regarding fertility rate, monthly conception rates averaged 53% in the control treatment observation and 58% with the hydroponically sprouted cereal grains treatment as shown in Table 2 below. On a monthly analysis, conception rate significantly increased 5.3% (p=0.016) with the inclusion of hydroponically sprouted cereal grains. Milk production may increase in some aspects of the present disclosure by at least 5%. In one aspect of the present disclosure, daily milk weights increased an estimated 5% adjusted for seasonality across all lactation groups when the ruminants switched to a feed composition including hydroponically sprouted cereal grains. Every kilogram of increased peak milk may be translated to roughly 200 kgs of additional milk per lactation. Conception rates, in some aspects of the present disclosure, may increase by at least 8%. These increase support improvements in milk production, ruminant health, and ruminant cow fertility after calving.

TABLE 2
Periparturient observation monthly fertility metrics

| Month | | Conception | | | Abort |
|---|---|---|---|---|---|
| Fresh | Treatment | (%) | #Pregnancy | #open | (%) |
| Jan. 2021 | Control | 55 | 178 | 143 | 3.7 |
| Feb. 2021 | Control | 54 | 155 | 132 | 3.4 |
| Mar. 2021 | Control | 53 | 175 | 154 | 3.3 |
| Apr. 2021 | Control | 53 | 139 | 122 | 2.3 |
| May. 2021 | Hydroponically | 61 | 156 | 99 | 3.1 |
| | sprouted cereal | | | | |
| | grains | | | | |
| Jun. 2021 | Hydroponically | 57 | 52 | 39 | 1.1 |
| | sprouted cereal | | | | |
| | grains | | | | |
| Nov. 2021 | Control | 50 | 136 | 138 | 2.5 |
| Dec. 2021 | Hydroponically | 57 | 171 | 128 | 3.0 |
| | sprouted cereal | | | | |
| | grains | | | | |
| Totals | | 55 | 1162 | 955 | 3.0 |

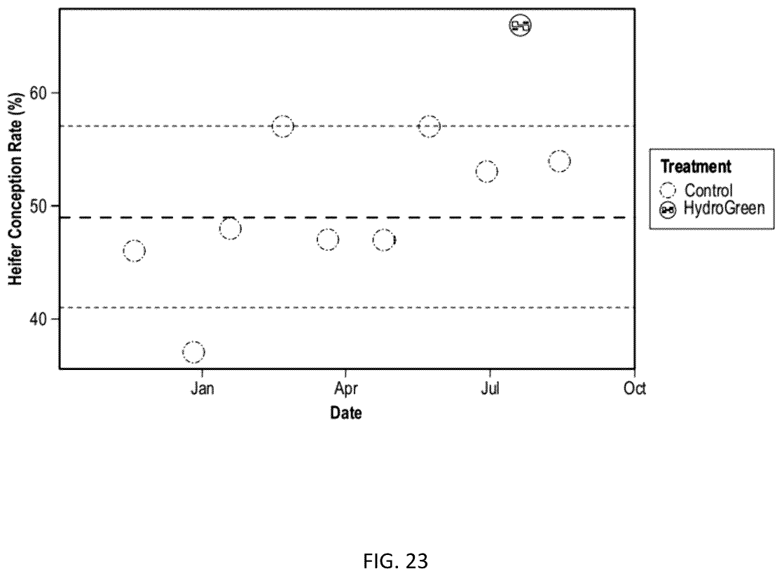

Measurements collected in the breeding heifer observation also support the positive fertility influence of hydroponically sprouted grains. In alignment with the periparturient observation, conception rate was observed to significantly increase with the inclusion of hydroponically sprouted cereal grains. On a monthly basis, conception rate was observed to increase 11% for the neighboring monthly average, as shown in FIG. 23. In some aspects of the present disclosure, the pregnancy rate may increase by 8%. In agreement with the previous observation, eating activity was observed to significantly increase with the inclusion of hydroponically sprouted cereal grains, as shown in Table 3. The annual estimated value, according to one aspect of the present disclosure, is an increase of $85 per heifer.

TABLE 3
Breeding Heifer observation statistical analysis

| | hydroponically | | | | | | |
|---|---|---|---|---|---|---|---|
| | sprouted cereal | | | | | | |
| Variable | grains | Control | SE | DF | Contrast | p-value | Unit |
| Eating | 496 | 467 | 4.2 | 451 | 29 | <0.00 | minutes |
| Heat Index | 7.5 | 6.8 | 0.2 | 451 | 0.6 | 0.013 | |
| Times Bred | 1.8 | 2.2 | 1 | 560 | 0.4 | 0.017 | count |
| Activity | 313 | 305 | 1.7 | 451 | 8 | <0.00 | |
| Anion Gap | 14.7 | 19.3 | 0.45 | 28 | −4.6 | <0.00 | mmol L⁻¹ |
| TCO₂ | 29.4 | 25.6 | 0.55 | 28 | 3.89 | <0.00 | mmol L⁻¹ |

Through increasing relative concentration of hexoses and in turn propionate, gluconeogenesis, and blood serum glucose and insulin levels, hydroponically sprouted cereal grains may be used as an approach to positively impact not only energy balance, but progesterone profile and ovulation rates in dairy cattle (Letelier et al., 2008; Dupont et al., 2014; Bedford et al., 2018). Hydrolysis reactions external to the rumen, e.g. enzymatic hydrolysis of hemicelluloses during germination; improve efficiency of energy utilization, reduce hydrogen dioxide and carbon dioxide formation within the rumen improving feed efficiency, lower the acetate to propionate volatile fatty acid ratio supporting positive progesterone profile shifts, improve gluconeogenesis supporting improved energy balance, and support the development of reproductive structures within the animal. Adding a nutritious hydroponically sprouted cereal grains to the feed composition allows complex carbohydrates to be more easily converted into digestible sugars and fibers, enabling better ration digestibility in the rumen and improved rumen health. Hydrolytic enzymes naturally occurring in the fresh plant enhance the digestibility and absorption of nutrients like vitamins and minerals from the ration as well as the overall diet, which can help prevent serious and costly metabolic disorders.

Conception rate improvements enabled through inclusion of hydroponically sprouted cereal grains were observed to increase fertility metrics not only in the periparturient to postpartum transitional phase, but also at the onset of maturity in dairy cattle. Estimated annual fertility benefits to a dairy operator are estimated to be valued at $41 and $85 per individual for the periparturient and breeding heifer observation respectively (De Vries, 2006). Fertility increases in the periparturient observation are likely partially resulting from a positive increase in metabolic energy balance through the positive changes to feeding behavior and nutrient digestibility. However, fertility increases in the breeding heifer observation are likely also partially due to positive changes in the rumen environment supporting increased levels of gluconeogenesis supporting progesterone expression and reproductive structure development (Dupont et al., 2014; Bedford et al., 2018). Positive changes in propionate levels are supported by large decreases in blood serum anion gap and increases in total carbon dioxide blood serum levels, as shown in Table 2. Results from the observation show promise to the novel approach of utilizing hydroponically sprouted grains as a fertility improvement strategy on dairy operations.

The variety of experiments demonstrated that hydroponically grown cereal grains had a positive effect on rumination activity both during the close-up period and early lactation. This is a very important aspect since reduced rumination result of reduced intakes or sorting during the transition period can predispose to subclinical and/or clinical acidosis. There was also a positive effect on milk production during the first three months of lactation distributed equally between both milkings. In summary, the use of the hydroponic grown cereal grains in the diet of close-up cows resulted not only in higher milk production throughout the first third of the lactation, but also improved other parameters that may lead to metabolic disorders such as acidosis and hypocalcemia.

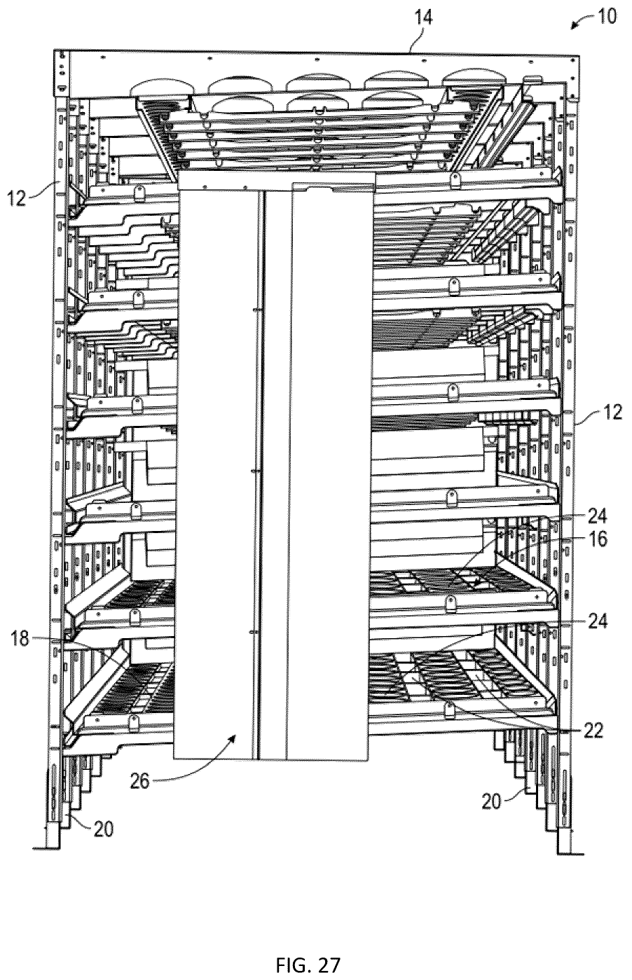

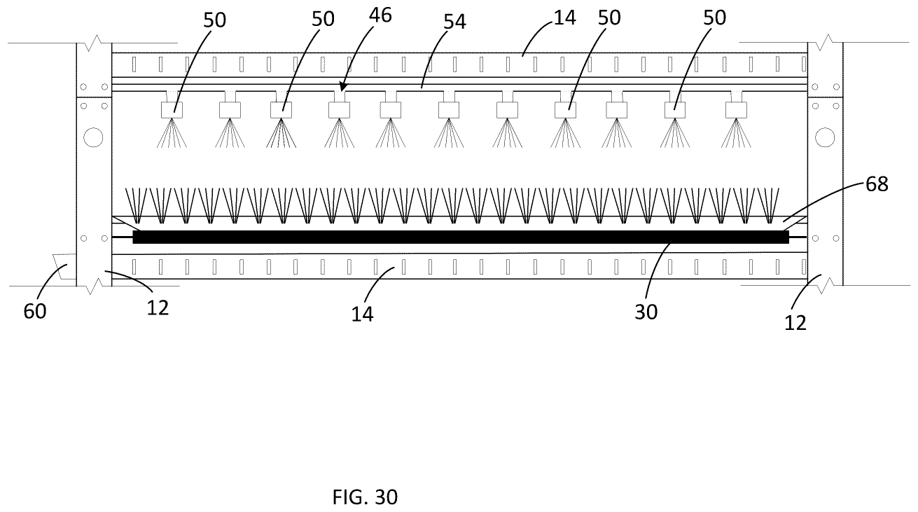

FIG. 27 illustrates a grower system 10. The grower system 10 can provide aerobic conditions allowing the plant to increase dry matter, maximize enzyme activity and increase sugar concentration. The grower system 10, shown in FIGS. 27-31 may include a plurality of vertical members 12 and a plurality of horizontal members 14 removably interconnected to form an upstanding seed growing table 16 with one or more seed beds 18. In some aspects of the present disclosure, the grower system 10 may have one or more seed beds 18. Each vertical member 12 can be configured to terminate at the bottom in an adjustable height foot 20. Each foot 20 can be adjusted to change the relative vertical position or height of one vertical member 12 relative to another vertical number 12 of the seed growing table 16. The horizontal member 14 can be configured to include one or more lateral members removably interconnected with one or more longitudinal members 24. A pair of vertical members 12 may be separated laterally by a lateral member 22 thereby defining the width or depth of the seed growing table 16. Longitudinal members 24 may be removably interconnected with lateral members 22 by one or more connectors 26.

Each seed bed 18 may include a seed belt 28, such as a seed film, operably supported by seed growing table 16. Seed belt 28 can be configured according to the width/depth of seed growing table 16. By way of example, the width/depth of seed belt 28 can be altered according to changes in the width/depth of seed growing table 16. The seed belt 28 material can be hydrophobic, semi-hydrophobic or permeable to liquid. In at least one aspect, a hydrophobic material may be employed to keep liquid atop the seed belt 28. In another aspect, a permeable or semi-permeable material can be employed to allow liquid to pass through the seed belt 28. Advantages and disadvantages of both are discussed herein. Traditional pans use hydrophobic material as part of the seed bed. This may increase water stress as water stays within the seed bed for prolonged periods, creating hypoxic conditions and increasing the concentration of ABA. The seeds use up the available oxygen. In one aspect, seed belt 28 may be discontinuous and may have separate or separated terminal ends. The seed belt 28 may have a length of at least the length of the seed bed 18 and generally a width of the seed bed 18 and may be configured to provide a seed bed for carrying seed. The seed belt 28 may be configured to move across the seed bed 18. Seed belt 28 may also rest upon and slide on top of horizontal members 14. One or more skids or skid plates (not shown) may be disposed between seed belt 28 and horizontal members 14 to allow seed belt 28 to slide atop horizontal members 14 without binding up or getting stuck. The seed bed 18 or seed belt 28 may be positioned at a slope to encourage the drainage of water facilitating an increased oxygenated environment when compared to a pan type fodder set up.

To provide room for expansion the seed belt 28 or seed bed 18 may have a seed egress 68 on one or more sides of the seed bed 18, such as a first side 70 and an opposing second side 72. The seed egress 68 allows room for expansion as the seeds grow, lessening the growth compression of the seeds. If the seed bed 18 has walls on the first side 70 or the second side 72, the walls may prevent the seeds from expanding thereby compressing some or all of the seeds. The compressed seeds may receive little to no oxygen resulting in hypoxic or anaerobic conditions. The seed egress 68 may not be covered with seeds during seed out. The empty space allows for expansion as the seed doubles in volume in the first few growth stages, such as in the first 24 hours. If the seeds do not have room to expand, the seed may be subjected to a dense environment with reduced heat, water, and oxygen exchange capabilities.

Each seed bed 18 may include a liquid applicator 46 operably configured atop each seed bed 18 for irrigating seed disposed atop each seed bed 18. The seed may be irrigated with water. The dimensions of the seed bed 18 may be configured to accommodate need, desired plant output, or maximization of enzyme activity. Liquid applicator 46 may be configured adjacent at least one longitudinal edge of seed bed 18. Liquid applicator 46 may also be operably configured adjacent at least one lateral edge of seed bed 18. Preferably, liquid applicator 46 may be configured adjacent a longitudinal edge of seed bed 18 to thereby provide drip-flood irrigation to seed bed 18 and seed 74 disposed atop seed bed 18. Liquid applicator 46 may include a liquid guide 48 and liquid distributor 50 with a liquid egress 52 having a generally undulated profile, such as a sawtooth or wavy profile generally providing peak (higher elevated) and valley (lower elevated) portions. Liquid applicator 46 can include a liquid line 54 configured to carry liquid 62 from a liquid source 56, such as a liquid collector 58 or plumbed liquid source 56. Liquid 62 may exit liquid line 54 through one or more openings and may be captured upon exiting liquid line 54 by liquid guide 48 and liquid distributor 50. The one or more openings in liquid line 54 can be configured as liquid drippers, intermittently dripping a known or quantifiable amount of liquid 62 over a set timeframe into liquid guide 48. The one or more openings may be configured intermittently along a length of liquid line 54 or dispersed in groupings along a length of liquid line 54. The one or more openings in liquid line 54 can be operably configured to equally distribute the liquid 62 down the seed bed 18 and slowly drip liquid into the seed bed 18. Drip or flood irrigating the growing surface provides a layer of liquid 62 for soaking the seed and can provide liquid 62 to seed 74 on seed bed 18 in a controlled, even distributive flow. Liquid distributor 50 can be configured with a liquid guide 48 adapted to collect liquid 62 as it exits liquid line 54. Collected liquid may be evenly distributed by liquid distributor 50 and exit the liquid distributor 50 onto the seed bed 18 via the liquid egress 52.

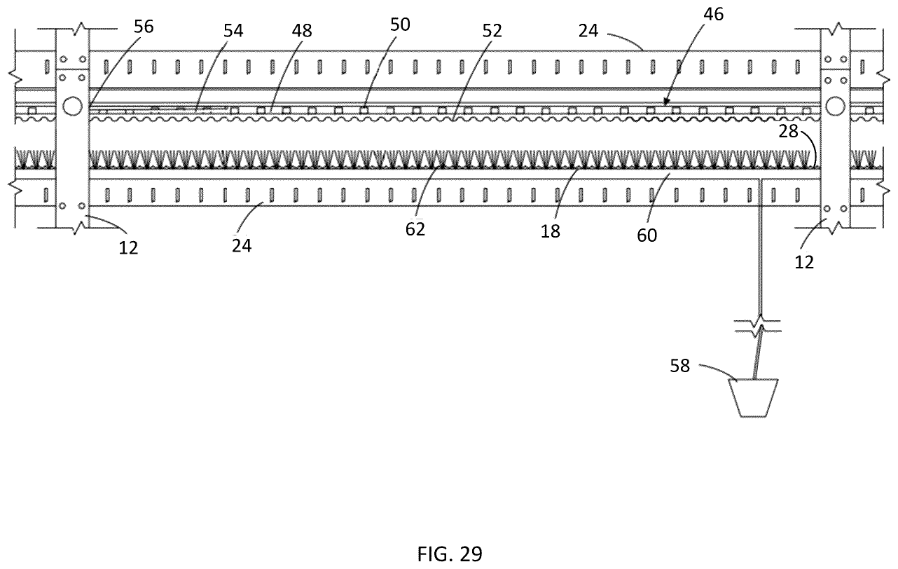

According to at least one aspect, liquid 62 egressing from liquid distributor 50 may travel atop seed belt 28 beneath. In another aspects of the present disclosure liquid may travel between the hydroponically sprouted cereal grains or seeds 74 atop seed bed 18 as shown in FIG. 29. Other configurations of liquid applicator 46 are also contemplated herein. For example, in one aspect, liquid 62 may enter liquid applicator 46 through a liquid line 54 and exit liquid line 54 through a plurality of openings. Liquid 62 from liquid line 54 may coalesce into a small reservoir creating a balanced distribution of liquid 62 across a length of liquid distributor 50. When this small reservoir becomes full, the liquid 62 may run over and out of liquid egress 52, such as between the teeth of liquid egress 52. In this manner, liquid 62 may be equally distributed down an entire length and across an entire width of the seed bed 18. From liquid egress 52, liquid 62 may drip onto a seed belt 28 where it may run under a bulk of hydroponically sprouted cereal grains 74 on the seed belt 28 to soak or make contact with the seed. The root system of hydroponically sprouted cereal grains 74 on the seed belt 28, along with a wicking effect, may move the liquid 62 up through the hydroponically sprouted cereal grains 74 to water all the seeds and/or plants.

Liquid applicator 46 may be disposed atop each seed bed 18. Liquid applicator 46 may include a plurality of liquid distributors 50 operably configured in a liquid line 54 operably plumbed to a liquid source 56. Liquid distributor 50 can include spray heads, such as single or dual-band spray heads/tips, for spray irrigating hydroponically sprouted cereal grains 74 disposed atop each seed bed 18. In one aspect, a plurality of liquid lines 54 may be disposed in a spaced arrangement atop each seed bed 18. Each liquid line 54 may traverse the length of the holding container and may be plumbed into connection with liquid source 56. Other liquid lines 54 can be configured to traverse the width of seed bed 18. Liquid 62 may be discharged from each liquid distributor 50 for spray irrigating hydroponically sprouted cereal grains 74 atop each seed bed 18. In another aspect, each liquid line 54 may be oscillated back and forth over a 10°, 15°, 20°, 25°, 35°, 40°, 45°, or greater radius of travel for covering the entire surface area of the hydroponically sprouted cereal grains 74 atop each seed bed 18. In the case where dual angle spray heads may be used for liquid distributor 50, the oscillation travel of each liquid line 54 can be reduced thereby reducing friction and wear and tear on liquid applicator 46. The process of applying liquid to the hydroponically sprouted cereal grains 74 or plant can be automated by a controller, graphical user interface, and/or remote control. A drive mechanism can be operably connected to each liquid line 54 for oscillating or rotating each line through a radius of travel. Liquid applicator 46 can be operated manually or automatically using one or more controllers operated by a control system 84.

Liquid applicator 46 may be configured to clean seed bed 18 of debris, contaminants, mold, fungi, bacteria, and other foreign/unwanted materials. Liquid applicator 46 can also be used to irrigate hydroponically sprouted cereal grains 74 with a disinfectant, nutrients, or reactive oxygen species as hydroponically sprouted cereal grains 74 is released onto seed bed 18 from a seed dispenser. A time delay can be used to allow the reactive oxygen species or nutrients to remain on hydroponically sprouted cereal grains 74 for a desired time before applying or irrigating with fresh water. The process of cleaning, descaling, and disinfecting seed bed 18 using liquid applicator 46 can be automated by a controller, graphical user interface, remote control and/or the control system 84.

Liquid applicator 46 can be operated immediately after seeding of the seed bed 18 to saturate hydroponically sprouted cereal grains 74 with liquid. Hydroponically sprouted cereal grains 74 in early, mid, and late stages of growth can be irrigated with liquid 62 using liquid applicator 46. Liquid applicator 46 can be operated simultaneously, intermittently, alternately, and independent of each other. During early stages of hydroponically sprouted cereal grains 74 growth, both liquid applicators can be operated to best saturate hydroponically sprouted cereal grains 74 to promote sprouting and germination. During later stages of growth, a first liquid applicator 46 can be used to irrigate more than a second liquid applicator 46, depending upon saturation level of hydroponically sprouted cereal grains 74 growth. Liquid applicator 46 can be operated during seeding of seed bed 18 and movement of seed bed 18 in the second direction to spray hydroponically sprouted cereal grains 74 dispensed atop seed bed 18 to saturate hydroponically sprouted cereal grains 74 with liquid. The liquid provided to liquid applicators 46 could include additives such as disinfectants, reactive oxygen species, fertilizer, and/or nutrients. Nutrients, such as commonly known plant nutrients such as calcium and magnesium, can be added to liquid dispensed from liquid applicators 46 to promote growth of healthy plants and/or increase the presence of desired nutrients in harvested seed. Liquid applicators 46 can be used also to sanitize seed bed 18 before and/or after winding on or unwinding of the seed belt, the seed bed 18, or seed egress 68 of the seed belt.

Liquid distributors 50 and their various components, along with other components of the grower system 10, can be sanitized by including one or more disinfectants, such as reactive oxygen species used by each liquid distributor 50. For example, liquid guide 48, liquid lines 54, liquid egress 52, drain trough 60, liquid collector 58, seed bed 18, liquid distributors 50, and other components of the growing system may be sanitized. In another aspect, liquid applicators 46 can be used to clean and sanitize seed bed 18 before, between, or after seeding and harvesting. A separate liquid distributor or manifold can be configured to disinfect or sanitize any components of the growing system that carry liquid for irrigation and cutting or receive irrigation or cutting runoff from the one or more holding containers.

The liquid 62 may be constantly applied, or the applicator may apply the liquid 62 at a set time frame or at a quantifiable amount. For example, the liquid applicator 46 may apply the liquid 62 for a first time period such as 1 minute and then the liquid applicator may stop applying the liquid 62 for a second time period, such as 4 minutes, or 1 min of liquid application for every 5 minutes. The cycle may continue until the developmental phase or seed out phase terminates. In another example, the liquid 62 may be applied for 10 min every 2 hours. The liquid applicator 46 may provide a controlled, evenly distributed flow allowing the liquid 62 to reach a maximum number of seeds. Excess liquid 62 may be captured, recycled, and reused by the grower system 10. If the seed bed 18 has an egress or a slant, the slant may aid in the even distribution of the liquid as it egresses through the seed bed 18. In some aspects, the liquid applicator 46 may guide the distribution of the liquid to areas within the seed bed 18, a portion of the seeds, or a portion of the plants that need more application. The liquid applicators 46 may also oscillate to cover the larger areas of the seed bed 18 or the entire length and width of the seed bed 18 or seed belt 28.

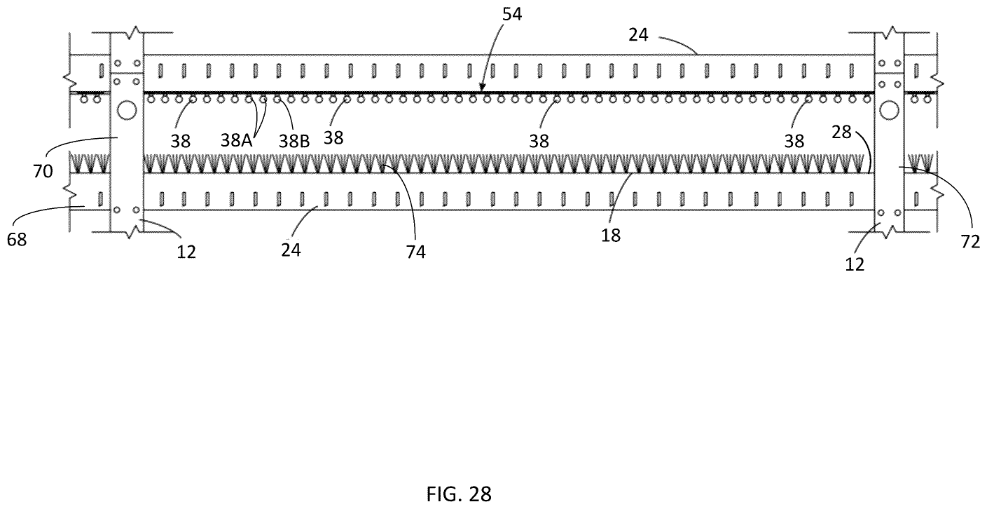

Each seed bed 18 may include one or more lighting elements 38 or housing lights for illuminating hydroponically sprouted cereal grains 74 atop seed belt 28 to facilitate hydroponic growth of hydroponically sprouted cereal grains 74 atop seed belt 28, as shown in FIG. 28. Lighting elements 38 may be operably positioned directly/indirectly above each seed bed 18. Lighting elements 38 can be turned off and on for each level using a controller 76 or the control system 84. In some aspects, one level of the grower system 10 may have the lighting elements 38 turned on while another level may have the lighting elements turned off. Lighting elements 38 can be powered by an electrochemical source or power storage device, electrical outlet, and/or solar power. In one aspect, lighting elements 38 may be powered with direct current power. Contemplated lighting elements 38 include, for example, halide, sodium, fluorescent, and LED strips/panels/ropes, but are not limited to those expressly provided herein. One or more reflectors (not shown) can be employed to redirect light from a remote source not disposed above each seed bed 18. Lighting elements 38 can be operably controlled by a controller, a timer, user interface, remotely or through the control system 84. Operation of lighting elements 38 can be triggered by one or more operations of grower system 10. For example, operation of a seed belt 28 can trigger operation of lighting elements 38. The process of lighting a seed bed 18 can be automated by controller, graphical user interface, and/or remote control. In one aspect, lighting elements 38 may be low heat emission, full ultraviolet (UV) spectrum, light emitting diodes that are cycled off and on with a controller, preferably on 18 hours and off 6 hours in a 24-hour period. The lighting elements 38 may emit multiple light frequencies at a specific ratio, such as a 2:1 ratio of R/FR light or the lighting elements may emit different light frequencies. For example, lighting element 38A may emit red light and lighting element 38B may emit white light. The lighting elements may be placed sequentially or in a pattern that permits the proper ration. The controller or control system 84 may control the frequency, intensity, or ratio of the lighting elements 38.

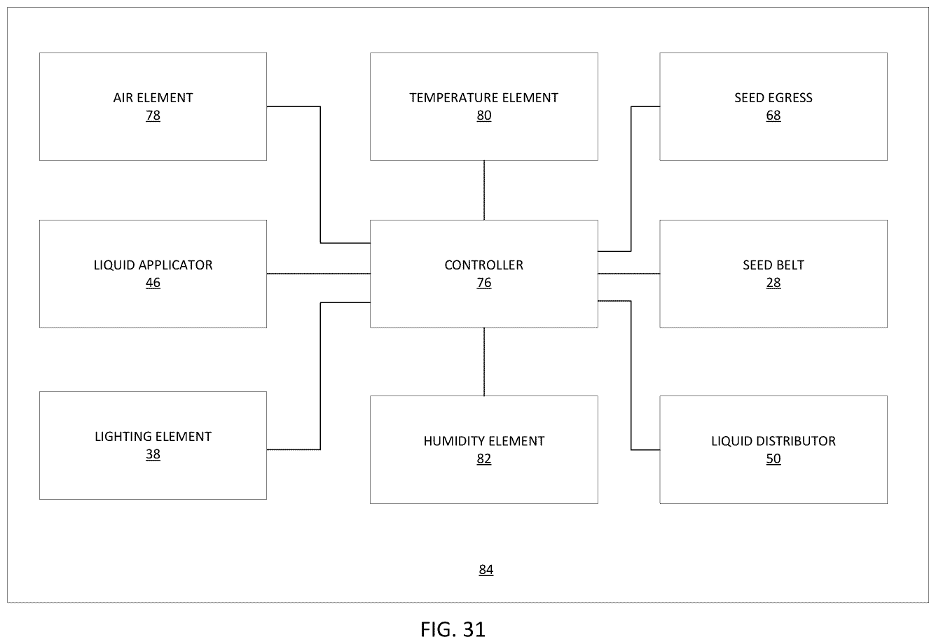

The grower system 10 may have a control system 84 for controlling different environmental conditions or operating conditions of the grower system. The control system 84 may control at least one air element 78 such as a fan or HVAC system to control air movement around the seed bed, as shown in FIG. 31. The air element 78 may be operably connected to the controller 76. A room or environment where the grower system 10 may be stored may also have one or more fans used to control air movement. The air movement or flow may be changed depending on the developmental phase of the hydroponically sprouted cereal grains 74 on the seed bed. A temperature element 80, such as an HVAC unit, may be operably connected to the grower system 10, controller 76, or the seed bed 18 to control the temperature of the environment of the seed bed 18. The temperature element 80 may maintain temperatures ranging of 65 to 85 degrees F. or 18 to 30 degrees C. A humidity element 82 may be operably connected to the controller, the control system 84, growing system 10, or seed bed 18 for controlling the humidity of the environment of the seed bed 18. The humidity element 82 may maintain a relative humidity level between 50% and 90%. The temperature element 80, air element 78, and humidity element 82 may all include the same HVAC unit. The temperature and air humidity may be changed depending on the developmental phase of the hydroponically sprouted cereal grains 74 on the seed bed 18. The process of controlling the air movement, temperature, and humidity of a seed bed 18 can be automated by controller, graphical user interface, remote control, and/or the control system. The lighting, temperature, air flow, and liquid application may all affect the humidity of the seed bed 18.

In hydroponic growing systems 10, plants may be suspended in water full-time or fed by an intermittent flow of water. Aeroponically sprouted and grown grains are generally given liquid nutrients as a mist. The present disclosure contemplates a grower system, similarly configured to grower system 10, for sprouting and growing grains using other soilless cultivation methods as set forth above and for achieving the benefits of the present disclosure.

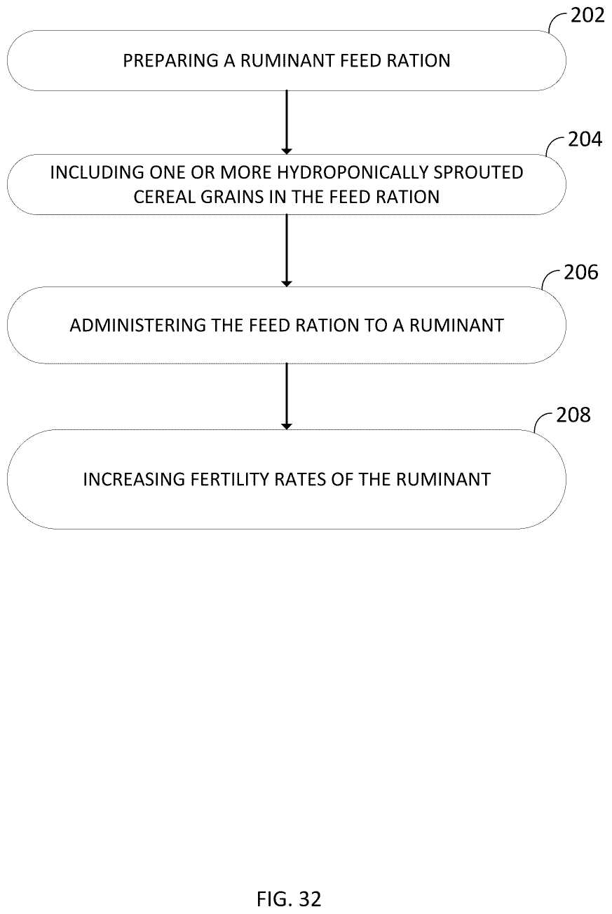

In at least one aspect of the present disclosure a method for increasing fertility rates is shown in FIG. 32. The method may include, for example, such steps as preparing a ruminant feed ration (Step 202), including one or more hydroponically sprouted cereal grains in the feed ration (Step 204), administering to a ruminant the feed ration (Step 206) having at least one feed component that includes one or more hydroponically sprouted cereal grains for increasing fertility rates in the ruminant (Step 208). The feed ration may increase dry matter intake of the ruminant. The fertility rates may be increased by increasing progesterone levels in the ruminant with the feed ration. The increase in progesterone levels may stimulate growth of reproductive structures. The feed ration may increase ovulation rates in the ruminate. The length of time between calving and a first ovulation cycle of a ruminant after calving may decrease with the feed ration. The method may further include reducing dihydrogen concentrations within the rumen with the feed ration. The method may also include lowering the acetate to propionate volatile fatty acid ratio and increasing glucose within the feed ration. In other exemplary aspects of the present disclosure the steps may include increasing metabolic energy in the ruminant with the feed ration, increasing milk production after calving or increasing gluconeogenesis in the ruminant with the feed ration, wherein the increased gluconeogenesis improve energy balance in the ruminant.

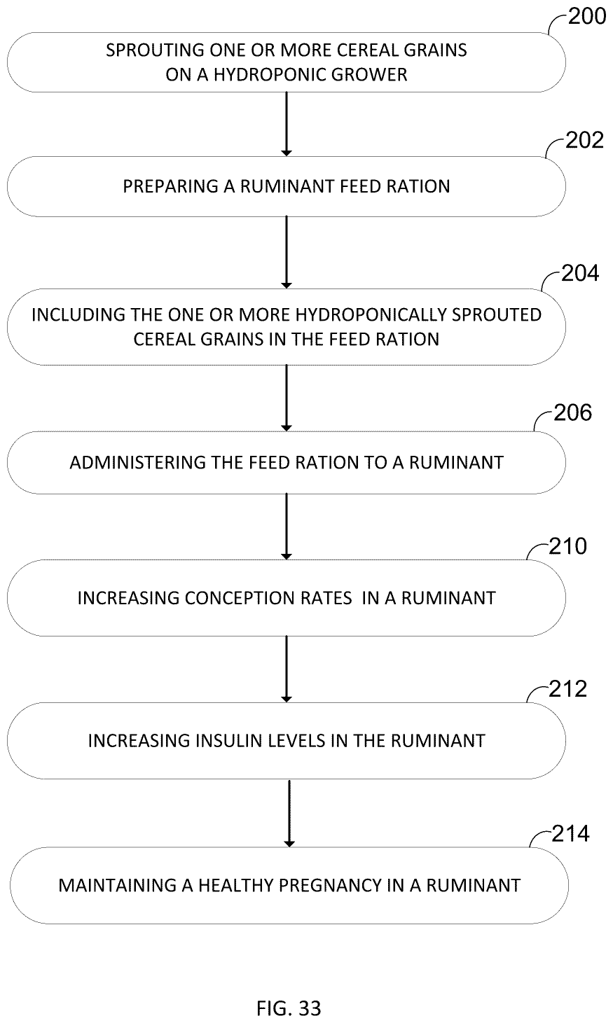

In another aspect of the present disclosure a method for increasing conception rates is disclosed and shown in FIG. 33. The method may include steps, such as, for example, sprouting one or more cereal grains on a hydroponic grower (Step 200) for preparing a ruminant feed ration (Step 202) by including the one or more hydroponically sprouted cereal grains in the feed ration (Step 204), administering the feed ration to a ruminant (Step 206), increasing conception rates from the ruminant (Step 210), increasing insulin levels in the ruminant (Step 212), and maintaining a healthy pregnancy (Step 214). The increase in insulin may levels supports the development of reproductive structures within the ruminant.

In other steps discussed and contemplated herein, but not necessarily explicitly enumerated in the figures, the method may include, such as, for example, increasing concentration of hexoses within the rumen with the feed ratio, increasing rates of gluconeogenesis within the rumen with the feed ration, reducing dihydrogen concentrations and lowering the acetate to propionate volatile fatty acid ratio within the rumen with the feed ration, increasing dry matter intake and increasing metabolic energy in the ruminant with the feed ration. In still another exemplary aspect, the steps may include, for example, increasing marbling and improving microbial activity and increasing microbial protein in the ruminant with the feed ration, increasing milk production postpartum, decreasing progesterone levels, and increasing conception rates at the onset of maturity. In another exemplary aspect, the method may include, for example, increasing efficiency of the feed ration having the at least one feed component comprising the one or more hydroponically sprouted cereal grains.

The disclosure is not to be limited to the particular aspects described herein. In particular, the disclosure contemplates numerous variations in increasing fertility rates, energy balance, postpartum milk production and maintaining a healthy pregnancy in a ruminant. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes, or methods of the disclosure. It is understood that any other modifications, substitutions, and/or additions can be made, which are within the intended spirit and scope of the disclosure.

What is claimed is:

1. A method for hydroponically sprouted cereal grains as a mechanism for increasing fertility rates in ruminants, the method comprising:
administering to a ruminant a feed ration having at least one feed component comprising one or more hydroponically sprouted cereal grains for increasing fertility rates in a ruminant.

2. The method of claim 1, further comprising:
increasing dry matter intake of the ruminant with the feed ration.

3. The method of claim 1, further comprising:
increasing ovulation rates of the ruminant with the feed ration.

4. The method of claim 1, further comprising:
reducing dihydrogen concentrations within the rumen with the feed ration;
lowering the acetate to propionate volatile fatty acid ratio; and
increasing glucose within the feed ration.

5. The method of claim 1, further comprising:
increasing metabolic energy in the ruminant with the feed ration.

6. The method of claim 1, further comprising:
increasing milk production after calving.

7. The method of claim 1, further comprising:
decreasing a length of time between calving and a first ovulation cycle of a ruminant after calving.

8. The method of claim 1, further comprising:
increasing gluconeogenesis in the ruminant with the feed ration, wherein the increased gluconeogenesis improve energy balance in the ruminant.

9. The method of claim 1, further comprising:
increasing efficiency of the feed ration having the at least one feed component comprising the one or more hydroponically sprouted cereal grains.

10. A method for increasing conception rates in a ruminant, the method comprising:
hydroponically sprouting one or more cereal grains for at least one feed component for ruminants;
feeding the ruminant a feed ration having the at least one feed component comprising the one or more hydroponically sprouted cereal grains for increasing conception rates in the ruminant;
increasing insulin levels in the ruminant with the feed ration; and
wherein the increase in insulin levels supports the development of reproductive structures within the ruminant.

11. The method of claim 10, further comprising:
increasing concentration of hexoses within the rumen with the feed ration.

12. The method of claim 10, further comprising:
increasing rates of gluconeogenesis within the rumen with the feed ration.

13. The method of claim 10, further comprising:
reducing dihydrogen concentrations within the rumen with the feed ration.

14. The method of claim 10, further comprising:
maintaining a health pregnancy of the ruminant with the feed ration.

15. The method of claim 10, further comprising:
decreasing a ratio of acetate to propionate within the rumen with the feed ration.

16. The method of claim 10, further comprising:
increasing dry matter intake of the ruminant with the feed ration.

17. A system for hydroponically sprouted cereal grains as a mechanism for increasing fertility rates of a ruminant, the system comprising:
a grower for hydroponically sprouting one or more cereal grains for growing at least one feed component for ruminants;
a feed ration having the at least one feed component comprising the one or more hydroponically sprouted cereal grains for increasing fertility rates in the ruminants.

18. The system of claim 17, wherein the feed ration having the at least one feed component comprising the one or more hydroponically sprouted cereal grains increases postpartum milk production.

19. The system of claim 17, wherein the feed ration having the at least one feed component comprising the one or more hydroponically sprouted cereal grains increases progesterone levels in the ruminants.

20. The system of claim 17, wherein the feed ration having the at least one feed component comprising the one or more hydroponically sprouted cereal grains improves maintenance of a healthy pregnancy.
